(19) United States
(12) Patent Application Publication
(10) Pub. No.: US 2023/0090501 A1
(43) Pub. Date: Mar. 23, 2023

(54) OPTICAL INTERFERENCE RANGE SENSOR

(71) Applicant: OMRON Corporation, Kyoto-shi (JP)

(72) Inventors: Yusuke NAGASAKI, Kyoto-shi (JP); Masayuki HAYAKAWA, Kyoto-shi (JP); Kazuya KIMURA, Kyoto-shi (JP); Hisayasu MORINO, Kyoto-shi (JP)

(73) Assignee: OMRON Corporation, Kyoto-shi (JP)

(21) Appl. No.: 17/895,114

(22) Filed: Aug. 25, 2022

(30) Foreign Application Priority Data
Sep. 15, 2021 (JP) 2021-150216

(51) Int. Cl. G01B 9/02017; G01B 9/02056

(52) U.S. Cl. CPC G01B 9/02017; G01B 9/02057

(57) ABSTRACT

A wavelength-swept light source projects a light beam. An interferometer includes a splitting unit that splits the light beam projected from the wavelength-swept light source into light beams radiated toward a plurality of spots on a measurement target. Each of the interference beam is generated by interference between a measurement beam radiated toward the measurement target and reflected at the measurement beam, and a reference beam passing through an optical path that is at least partially different from an optical path of the measurement beam. A light-receiving unit receives the interference beams from the interferometer. A processor calculates distance to the measurement target by associating a detected peak of the interference beams with one of the spots. The optical path length difference between the measurement target and the reference beam is made different among the light beams split in correspondence with the plurality of spots.

### CROSS-REFERENCES TO RELATED APPLICATIONS

This application claims priority to Japanese Patent Application No. 2021-150216 filed on Sep. 15, 2021, the entire contents of which are incorporated herein by reference.

### FIELD

The disclosure relates to an optical interference range sensor.

### BACKGROUND

In recent years, optical range sensors that contactlessly measure the distance to a measurement target have been widely used. For example, known optical range sensors include optical interference range sensors that generate an interference beam by interference between a reference beam and a measurement beam from a light beam projected from a wavelength-swept light source and measure the distance to a measurement target based on the interference beam.

Further, known conventional optical interference range sensors also include sensors that are configured to radiate a plurality of beams toward a measurement target to measure the measurement target with high accuracy.

In an optical measurement device described in JP 268612462, stable measurement results are obtained by causing a return light beam component of a reference beam reflected at a plurality of optical fiber end faces and a reflection component of a measurement beam reflected at the surface of a measurement target to coherently interfere with each other.

JP 268612462 is an example of background art.

### SUMMARY

However, even if conventional optical interference range sensors are configured to radiate a plurality of beams toward a measurement target, these sensors are unable to appropriately measure the distance because, for example, peaks of the interference beams overlap or the peaks cannot be recognized, depending on the shape of the measurement target.

One or more embodiments may provide an optical interference range sensor capable of appropriately recognizing a peak of each interference beam and measuring a distance with high accuracy.

An optical interference range sensor according to one or more embodiments includes: a light source configured to project a light beam while continuously varying a wavelength thereof; an interferometer including a splitting unit configured to split the light beam projected from the light source into light beams radiated toward a plurality of spots on a measurement target, the interferometer being configured to generate interference beams with the light beams split in correspondence with the plurality of spots, each of the interference beams being generated by interference between a measurement beam radiated toward the measurement target and reflected at the measurement target and a reference beam passing through an optical path that is at least partially different from an optical path of the measurement beam; a light-receiving unit configured to receive the interference beams from the interferometer; and a processor configured to detect a peak of the received interference beams, and calculate a distance to the measurement target by associating the detected peak with one of the plurality of spots, wherein an optical path length difference between the measurement beam and the reference beam is different among the light beams split in correspondence with the plurality of spots.

According to one or more embodiments, the interferometer generates an interference beam by interference between the measurement beam that is radiated toward the measurement target and reflected at the measurement target and the reference beam passing through an optical path that is at least partially different from the optical path of the measurement beam, for each of the light beams split in correspondence with the plurality of spots. The light-receiving unit receives the interference beams from the interferometer. The processor detects peaks of the interference beams, and calculates the distance to the measurement target by associating the detected peaks with the respective spots. Also, the optical path length difference between the measurement beam and the reference beam is made different among the light beams split in correspondence with the plurality of spots. Therefore, the peaks may be appropriately detected, and the distance to the measurement target may be calculated with high accuracy based on the distance values corresponding to the detected peaks.

In one or more embodiments, peaks of the interference beams may be shifted from each other.

According to one or more embodiments, the peaks of the interference beams are shifted. Therefore, the peaks may be detected more appropriately.

In one or more embodiments, the interferometer may generate each of the interference beams by interference between a first reflected beam that is a reflected beam of the measurement beam radiated toward the measurement target and reflected at the measurement target and a second reflected beam that is a reflected beam of the reference beam reflected at a reference surface.

According to one or more embodiments, each interference beam is generated by interference between on the first reflected beam that is a reflected beam of the measurement beam radiated toward the measurement target and reflected at the measurement target and the second reflected beam that is a reflected beam of the reference beam reflected at the reference surface. The optical path length difference between the measurement beam and the reference beam is made different among the light beams split in correspondence with the plurality of spots. Therefore, the peaks may be appropriately detected, and the distance to the measurement target may be calculated with high accuracy based on the distance values corresponding to the detected peaks.

In one or more embodiments, positions of leading ends of optical fiber cables for transmitting the respective light beams split in correspondence with the plurality of spots may be shifted with respect to each other in an optical axis direction, each of the leading ends serving as the reference surface.

According to one or more embodiments, the leading end positions of the optical fiber cables arranged in the optical paths are shifted in the optical axis direction. Therefore, the optical path length differences in the optical paths may be made different, and the peaks may be detected more appropriately.

In one or more embodiments, a difference ΔL in the optical path length difference among the light beams split in correspondence with the plurality of spots may be at least larger than a distance resolution δL_{FWHM}, which is represented by:

δL_{FWHM}=c/nδf

(where c: speed of light, n: refractive index in optical path difference, δf: frequency sweep width).

According to one or more embodiments, the difference ΔL in the optical path length difference between the optical paths is made larger than the distance resolution δL_{FWHM}. It may be, therefore, possible to reduce overlapping of a plurality of peaks of the interference beams and detect these peaks more appropriately.

In one or more embodiments, the optical path length difference may be set so that distances between adjacent peaks of the interference beams are different, and the processor may calculate the distance to the measurement target by associating the detected peak with the one of the spots, based on the distances between the adjacent peaks and a preset optical path length difference.

According to one or more embodiments, the optical path length difference is set so that the distances between adjacent peaks of the interference beams are different. Therefore, even if a peak of any of the interference beams disappears, the spots to which detected peaks correspond may be appropriately determined based on the peak-to-peak distance between the detected peaks.

In one or more embodiments, the processor may calculate the distance to the measurement target by associating the detected peak with the one of the spots, based on the detected peak and a detected peak of an interference beam received in the past.

According to one or more embodiments, the currently detected peak is determined based on a detected peak of each interference beam received in the past. Therefore, even if some peaks of the interference beams disappear and only one peak is detected, the one peak may be appropriately associated with a spot. As a result, the distance to the measurement target may be calculated without causing a significant error.

In one or more embodiments, the light-receiving unit may include an adjustment unit configured to equalize an amount of light of the interference beams corresponding to the respective spots.

According to one or more embodiments, the adjustment unit equalizes the amount of light of the interference beams that correspond to the respective spots. It may be, therefore, possible to suppress a peak corresponding to a spot of each interference beam from being canceled by the other peaks, and to detect a peak corresponding to each spot more appropriately.

In one or more embodiments, the processor may generate a signal waveform by converting, to a distance by means of sub-pixel estimation, discrete values obtained by frequency-analyzing the interference beams received by the light-receiving unit.

According to one or more embodiments, the processor generates a signal waveform converted into distance by means of sub-pixel estimation. It may be, therefore, possible to detect a peak with higher accuracy and calculate the distance corresponding to the peak.

In one or more embodiments, the processor may obtain the distance to the measurement target by averaging distance values calculated by associating the detected peak with the one of the spots.

According to one or more embodiments, the processor calculates the distance to the measurement target by further averaging the distance values that are calculated by associating the detected peaks with the spots. Therefore, the processor, as a multi-channel sensor, may calculate the distance to the measurement target with higher accuracy.

In one or more embodiments, the processor may obtain the distance to the measurement target by averaging distance values calculated based on a peak having a signal intensity that is not smaller than a predetermined value, out of a plurality of the detected peaks.

According to one or more embodiments, the processor may calculate the distance to the measurement target T with higher accuracy by only averaging distance values corresponding to peaks with large signal intensities, out of the detected peaks.

According to one or more embodiments, an optical interference range sensor may be provided that is capable of appropriately recognizing a peak of each interference beam and measuring a distance with high accuracy.

### BRIEF DESCRIPTION OF THE DRAWINGS

FIG. 1 is a schematic diagram illustrating an external appearance of an outline of a displacement sensor according to one or more embodiments.

FIG. 2 is a flowchart illustrating a procedure for measuring a measurement target with use of a displacement sensor according to one or more embodiments.

FIG. 3 is a functional block diagram illustrating an overview of a sensor system that uses a displacement sensor according to one or more embodiments.

FIG. 4 is a flowchart illustrating a procedure for measuring a measurement target with use of a sensor system that uses a displacement sensor according to one or more embodiments.

FIG. 5A is a diagram illustrating a principle by which a displacement sensor according to one or more embodiments measures a target object.

FIG. 5B is a diagram illustrating another principle by which a displacement sensor according to one or more embodiments measures a measurement target.

FIG. 6A is a diagram illustrating a perspective view of a schematic configuration of a sensor head.

FIG. 6B is a diagram illustrating a perspective view of a schematic configuration of a collimating lens holder arranged within a sensor head.

FIG. 6C is a diagram illustrating a cross-sectional view of an internal structure of a sensor head.

FIG. 7 is a block diagram illustrating signal processing performed by a controller.

FIG. 8 is a flowchart illustrating a method for calculating a distance to a measurement target that is executed by a processor of a controller.

FIG. 9A is a diagram illustrating how a waveform signal (voltage vs time) is subjected to frequency conversion into a spectrum (voltage vs frequency).

FIG. 9B is a diagram illustrating how a spectrum (voltage vs frequency) is subjected to distance conversion into a spectrum (voltage vs distance).

FIG. 9C is a diagram illustrating how a value (distance, SNR) corresponding to a peak is calculated based on a spectrum (voltage vs distance).

FIG. 10 is a schematic diagram illustrating a schematic configuration of an optical interference range sensor according to one or more embodiments.

FIG. 11 is a flowchart illustrating a method for calculating a distance to a measurement target that is executed by a processor.

FIG. 12 is a schematic diagram illustrating an example of a signal waveform obtained by converting return beams received by a light receiving unit into distance.

FIG. 13 is a diagram illustrating coherent FMCW (Frequency-Modulated Continuous Wave).

FIG. 14 is a flowchart illustrating a method for calculating a distance to a measurement target while giving consideration to a case where peaks of return beams received by a light receiving unit disappear.

FIG. 15 is a diagram illustrating how peaks are detected based on a signal that is subjected to distance conversion into a spectrum (voltage vs distance).

FIG. 16 is a diagram illustrating how processing is executed, such as in steps S241 to S243 disclosed herein, based on one detected peak, such as peak S1 as disclosed herein.

FIG. 17 is a diagram illustrating how processing is executed, such as in steps in steps S251 to S253 disclosed herein, based on two detected peaks, such as peaks S1 and S2 as disclosed herein.

FIG. 18 is a diagram illustrating a relationship between a peak-to-peak distance and peaks corresponding to three spots (which correspond to optical paths A to C).

FIG. 19 is a diagram illustrating how processing is executed, such as in step S260 disclosed herein, based on three detected peaks, such as peaks S1, S2, and S3 as disclosed herein.

FIG. 20 is a diagram illustrating how distance values corresponding to detected peaks are corrected and averaged based on a amounts of shift, in an optical axis direction, of leading end positions of optical fibers arranged in respective optical paths A to C.

FIG. 21 is a diagram illustrating how an adjustment unit adjusts a amounts of light of return beams received by an adjustment unit.

FIG. 22 is a diagram illustrating how a signal waveform converted into distance by means of sub-pixel estimation is generated.

FIGS. 23A, 23B and 23C are diagrams illustrating variations of interferometers that generate an interference beam using a measurement beam and a reference beam.

### DETAILED DESCRIPTION

One or more embodiments will be described in detail with reference to the attached drawings. Note that the following embodiment is only for giving specific examples for carrying out one or more embodiments, and is not intended to interpret one or more embodiments in a limited manner. To facilitate understanding of the description, the same constituent elements in the drawings are assigned the same signs to the extent possible, and redundant descriptions may be omitted.

### Summary of Displacement Sensor

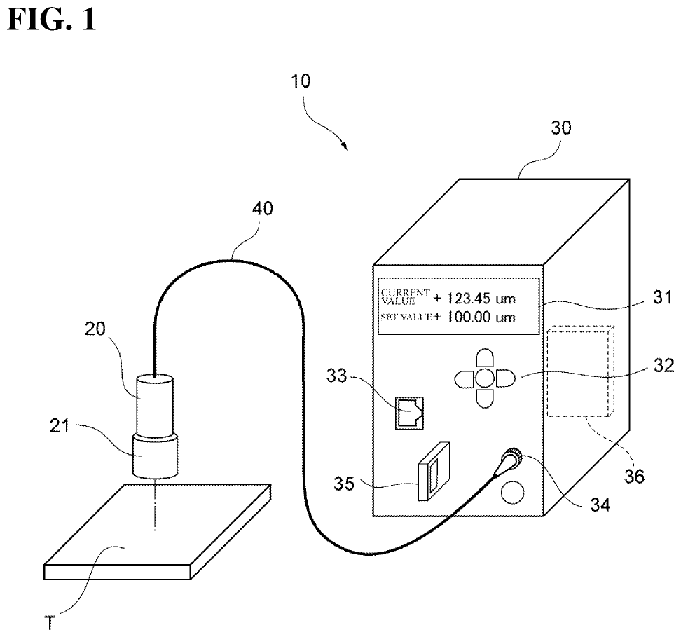

Firstly, a summary of a displacement sensor according to the present disclosure will be described. FIG. 1 is a schematic diagram of an external appearance showing an outline of a displacement sensor 10 according to the present disclosure. As shown in FIG. 1, the displacement sensor 10 includes a sensor head 20 and a controller 30, and measures displacement of a measurement target T (distance to the measurement target T).

The sensor head 20 and the controller 30 are connected by an optical fiber cable 40. An objective lens 21 is attached to the sensor head 20. The controller 30 includes a display unit 31, a setting unit 32, an external interface (I/F) unit 33, an optical fiber cable connector 34, and an external storage unit 35, and also contains a measurement processor 36.

The sensor head 20 radiates a light beam output from the controller 30 toward the measurement target T, and receives a reflected beam from the measurement target T. The sensor head 20 contains reference surfaces for reflecting a light beam that is output from the controller 30 and received via the optical fiber cable 40 and causing the reflected beam to interfere with the aforementioned reflected beam from the measurement target T.

Note that the objective lens 21 attached to the sensor head 20 is removable. The objective lens 21 can be replaced by another objective lens having an appropriate focal length in accordance with the distance between the sensor head 20 and the measurement target T. Alternatively, a variable-focus objective lens may be used.

Furthermore, when the sensor head 20 is installed, a guide beam (visible light) may be radiated toward the measurement object T, and the sensor head 20 and/or the measurement object T may be placed so that the measurement object T is appropriately positioned within a measurement area of the displacement sensor 10.

The optical fiber cable 40 is connected to the optical fiber cable connector 34 arranged on the controller 30 and connects the controller 30 to the sensor head 20. The optical fiber cable 40 thus guides a light beam projected from the controller 30 to the sensor head 20 and also guides return beams from the sensor head 20 to the controller 30. Note that the optical fiber cable 40 can be attached to and detached from the sensor head 20 and the controller 30, and may be an optical fiber with any of various lengths, thicknesses, and characteristics.

The display unit 31 is a liquid crystal display, an organic EL display, or the like, for example. The display unit 31 displays set values for the displacement sensor 10, the amount of light of return beams from the sensor head 20, and measurement results such as displacement of the measurement target T (distance to the measurement target T) measured by the displacement sensor 10.

The setting unit 32 allows a user to operate a mechanical button or a touch panel, for example, to configure settings necessary for measuring the measurement target T. Some or all of these necessary settings may be configured in advance, or may be configured from an externally connected device (not shown) that is connected to the external I/F unit 33. The externally connected device may be connected by wire or wirelessly via a network.

Here, the external I/F unit 33 is constituted by, for example, Ethernet (registered trademark), RS232C, analog output, or the like. The external I/F unit 33 may be connected to another connection device so that necessary settings are configured from the externally connected device, and may also output the results of measurement performed by the displacement sensor 10 to the externally connected device, for example.

Further, settings necessary for measuring the measurement target T may also be configured by the controller 30 retrieving data stored in the external storage unit 35. The external storage unit 35 is an auxiliary storage device such as a USB (Universal Serial Bus) memory. Settings or the like necessary for measuring the measurement target T are stored therein in advance.

The measurement processor 36 in the controller 30 includes, for example, a wavelength-swept light source that projects a light beam while continuously varying the wavelength, light-receiving elements that receive return beams from the sensor head 20 and convert the received beams to an electrical signal, a signal processing circuit that processes the electrical signal, and the like. The measurement processor 36 performs various processes using a controller, a storage, and the like based on return beams from the sensor head 20 so that the displacement of the measurement target T (distance to the measurement target T) is ultimately calculated. The details of the processing will be described later.

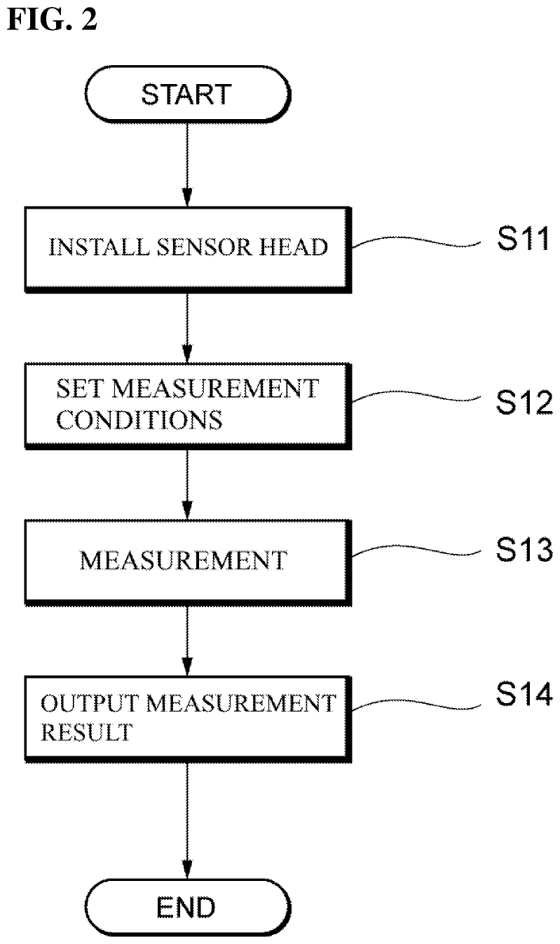

FIG. 2 is a flowchart showing a procedure for measuring a measurement target T with use of the displacement sensor 10 according to the present disclosure. The procedure includes steps S11 to S14, as shown in FIG. 2.

In step S11, the sensor head 20 is installed. For example, a guide beam is radiated from the sensor head 20 toward the measurement target T, and the sensor head 20 is installed at an appropriate position while referencing the radiated guide light.

Specifically, the amount of light of return beams received from the sensor head 20 may be displayed in the display unit 31 in the controller 30. The user may also adjust the orientation of the sensor head 20, the distance (height position) to the measurement target T, or the like while checking the amount of received light. Basically, if the light beam from the sensor head 20 is radiated more vertically (at an angle closer to vertical) relative to the measurement target T, the amount of light of reflected beams from the measurement target T becomes larger, and the amount of light of return beams received from the sensor head 20 also becomes larger.

The objective lens 21 may also be replaced with one having an appropriate focal length in accordance with the distance between the sensor head 20 and the measurement target T.

If appropriate settings cannot be configured (e.g., a necessary amount of received light for measurement cannot be obtained, or the focal length of the objective lens 21 is inappropriate etc.) when the measurement target T is measured, the user may be notified by displaying an error message, an incomplete setting message, or the like in the display unit 31 or outputting such a message to the externally connected device.

In step S12, various measurement conditions are set to measure the measurement target T. For example, the user sets unique calibration data (function etc. for correcting linearity) that the sensor head 20 has by operating the setting unit 32 in the controller 30.

Various parameters may also be set. For example, the sampling time, the measurement range, a threshold for determining whether to regard measurement results as normal or abnormal, or the like are set. Further, a measurement period may be set in accordance with characteristics of the measurement target T, such as the reflectance and material of the measurement target T, and a measurement mode or the like corresponding to the material of the measurement target T may also be set.

Note that these measurement conditions and various parameters are set by operating the setting unit 32 in the controller 30, but may alternatively be set from the externally connected device or may be set by retrieving data from the external storage unit 35.

In step S13, the measurement target T is measured with the sensor head 20 installed in step S11 in accordance with the measurement conditions and various parameters that are set in step S12.

Specifically, in the measurement processor 36 in the controller 30, the wavelength-swept light source projects a light beam, the light-receiving elements receive return beams from the sensor head 20, the signal processing circuit performs, for example, frequency analysis, distance conversion, peak detection, and the like to calculate displacement of the measurement target T (distance to the measurement target T). The details of specific measurement processing will be described later.

In step S14, the result of measurement in step S13 is output. For example, the displacement of the measurement target T (distance to the measurement target T) or the like measured in step S13 is displayed in the display unit 31 in the controller 30 or output to the externally connected device.

In addition, whether the displacement of the measurement target T (distance to the measurement target T) measured in step S13 is in a normal range or is abnormal based on the threshold set in step S12 may also be displayed or output as a measurement result. Furthermore, the measurement conditions, various parameters, the measurement mode, or the like that are set in step S12 may also be displayed or output together.

Overview of a System that Includes a Displacement Sensor

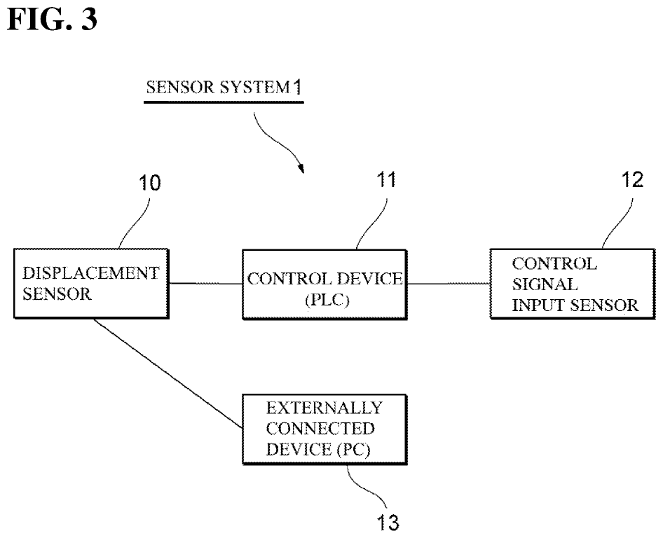

FIG. 3 is a functional block showing an overview of a sensor system 1 that uses the displacement sensor 10 according to one or more embodiments. The sensor system 1 includes the displacement sensor 10, a control device 11, a control signal input sensor 12, and an externally connected device 13, as shown in FIG. 3. Note that the displacement sensor 10 is connected to the control device 11 and the externally connected device 13 by a communication cable or an external connection code (which may include an external input line, an external output line, a power line, etc.), for example. The control device 11 and the control signal input sensor 12 are connected by a signal line.

The displacement sensor 10 measures displacement of the measurement target T (distance to the measurement target T), as described with reference to FIGS. 1 and 2. The displacement sensor 10 may also output the measurement results or the like to the control device 11 and the externally connected device 13.

The control device 11 is a PLC (Programmable Logic Controller), for example, and gives the displacement sensor 10 various instructions when the displacement sensor 10 measures the measurement target T.

For example, the control device 11 may output a measurement timing signal to the displacement sensor 10 based on an input signal from the control signal input sensor 12 connected to the control device 11, and may also output a zero-reset command signal (a signal for setting a current measurement value to 0) or the like to the displacement sensor 10.

The control signal input sensor 12 outputs, to the control device 11, an on/off signal to indicate the timing for the displacement sensor 10 to measure the measurement target T. For example, the control signal input sensor 12 may be installed near a production line in which the measurement target T moves, and may output the on/off signal to the control device 11 in response to detecting that the measurement target T has moved to a predetermined position.

The externally connected device 13 is a PC (Personal Computer), for example. The user can configure various setting to the displacement sensor 10 by operating the externally connected device 13.

As a specific example, the measurement mode, the work mode, the measurement period, the material of the measurement target T, and the like are set.

An “internally synchronized measurement mode”, in which measurement periodically starts within the control device 11, or an “externally synchronized measurement mode”, in which measurement starts in response to an input signal from outside the control device 11, or the like can be selected as a setting of the measurement mode.

An “operation mode”, in which the measurement target T is actually measured, an “adjustment mode”, in which measurement conditions for measuring the measurement target T are set, or the like can be selected as a work mode setting.

The “measurement period” refers to a period for measuring the measurement target T and may be set in accordance with the reflectance of the measurement target T. Even if the measurement target T has a low reflectance, the measurement target T can be appropriately measured by lengthening the measurement period to set an appropriate measurement period.

As a mode for the measurement target T, a “rough surface mode”, which is suitable when the components of the reflected beam reflected from the measurement target T include a relatively large diffuse reflection, a “specular mode”, which is suitable when the components of the reflected beam include a relatively large specular reflection, an intermediate “standard mode”, or the like can be selected.

Thus, the measurement target T can be measured with higher accuracy by configuring appropriate settings in accordance with the reflectance and material of the measurement target T.

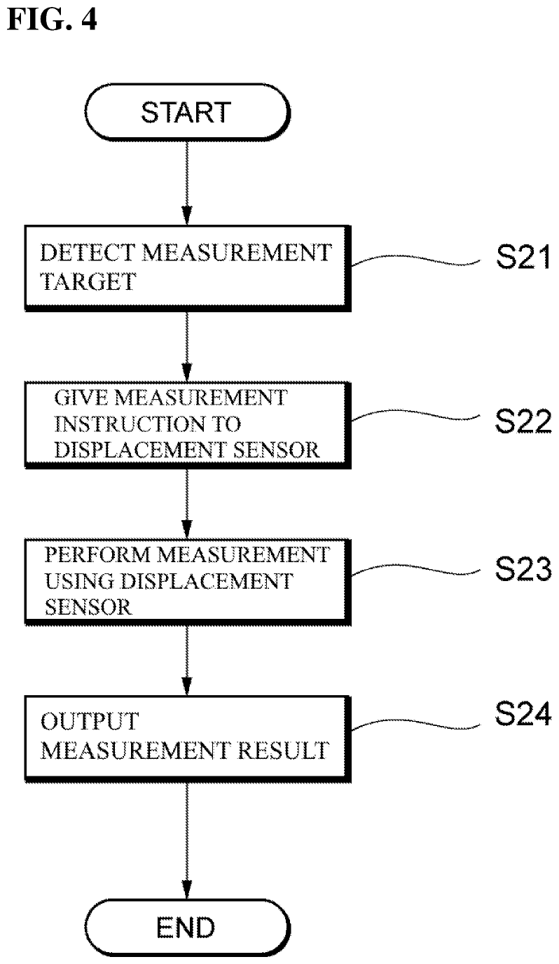

FIG. 4 is a flowchart showing a procedure for measuring the measurement target T with use of the sensor system 1 that uses the displacement sensor 10 according to the present disclosure. As shown in FIG. 4, the illustrated procedure is for the case of the aforementioned externally synchronized measurement mode and includes steps S21 to S24.

In step S21, the sensor system 1 detects the measurement target T, which is an object to be measured. Specifically, the control signal input sensor 12 detects that the measurement target T has moved to a predetermined position on a production line.

In step S22, the sensor system 1 gives an instruction to measure the measurement target T detected in step S21, with use of the displacement sensor 10. Specifically, the control signal input sensor 12 indicates the timing of measuring the measurement target T detected in step S21 by outputting an on/off signal to the control device 11. The control device 11 outputs a measurement timing signal to the displacement sensor 10 based on the on/off signal to give an instruction to measure the measurement target T.

In step S23, the displacement sensor 10 measures the measurement target T. Specifically, the displacement sensor 10 measures the measurement target T based on the measurement instruction received in step S22.

In step S24, the sensor system 1 outputs the result of measurement in step S23. Specifically, the displacement sensor 10 causes the display unit 31 to display the result of measurement processing, and/or outputs the result to the control device 11, the externally connected device 13, or the like via the external I/F unit 33.

Note that the above description has been given, with reference to FIG. 4, of the procedure in the case of the externally synchronized measurement mode in which the measurement target T is measured upon the control signal input sensor 12 detecting the measurement target T. However, there is no limitation thereto. In the case of the internally synchronized measurement mode, for example, an instruction to measure the measurement target T is given to the displacement sensor 10 upon a measurement timing signal being generated based on a preset period, instead of steps S21 and S22.

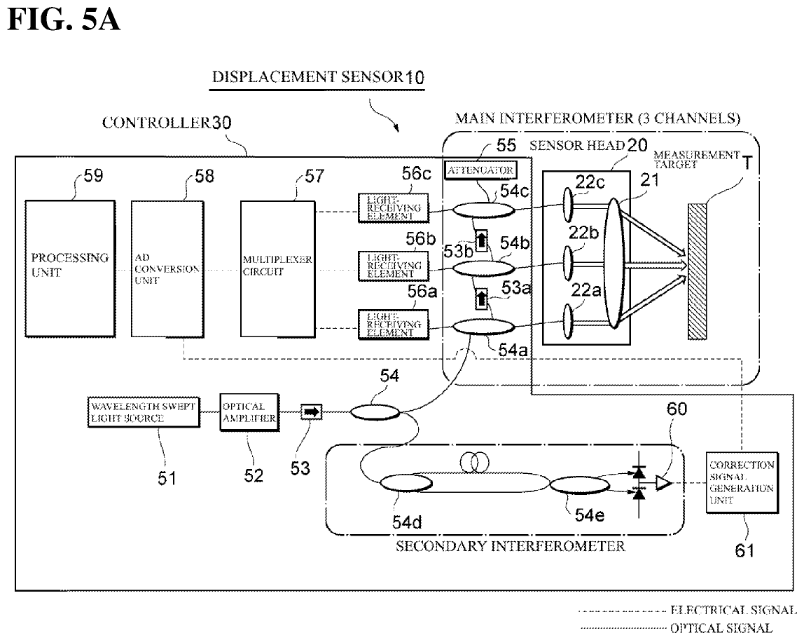

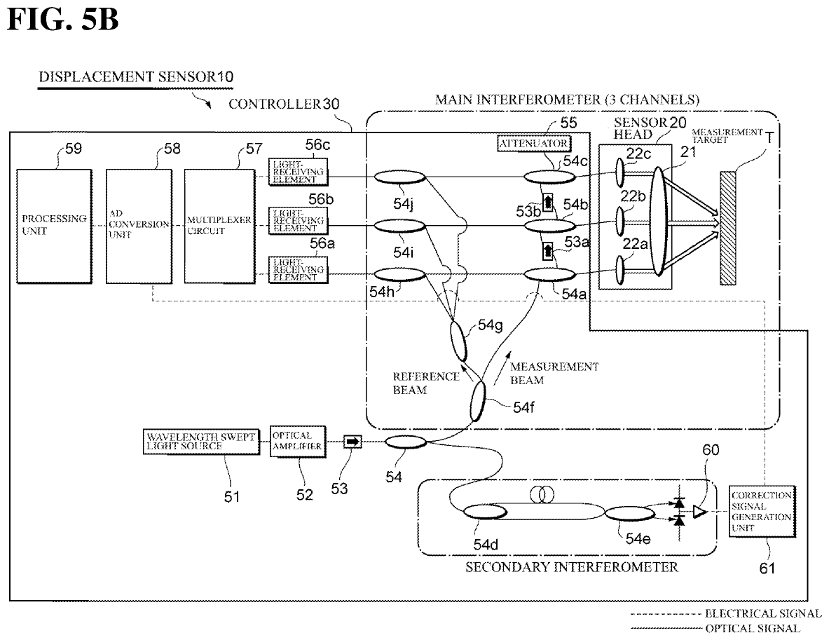

Next, a description will be given of the principle by which the displacement sensor 10 according to the present disclosure measures the measurement target T. FIG. 5A is a diagram illustrating a principle by which the displacement sensor 10 according to the present disclosure measures a measurement target T. As shown in FIG. 5A, the displacement sensor 10 includes the sensor head 20 and the controller 30. The sensor head 20 includes the objective lens 21 and a plurality of collimating lenses 22a to 22c. The controller 30 includes a wavelength-swept light source 51, an optical amplifier 52, a plurality of isolators 53, 53a, and 53b, a plurality of optical couplers 54 and 54a to 54e, an attenuator 55, a plurality of light-receiving elements (e.g., photodetectors (PD)) 56a to 56c, a multiplexer circuit 57, an analog-to-digital (AD) conversion unit (e.g., analog-to-digital converter) 58, a processor (e.g., processor) 59, a balance detector 60, and a correction signal generation unit 61. Each optical coupler 54, 54a to 54e has 2×2 (four) ports. A light beam input to a port at one end is output to two ports at the other end at a predetermined split ratio. Specifically, the first-stage optical coupler 54a has a first port, a second port, a third port, and a fourth port. A light beam input to the first port or the second port is output to the third port and the fourth port at a predetermined split ratio. A light beam input to the third port or the fourth port is output to the first port and the second port at a predetermined split ratio.

The wavelength-swept light source 51 projects a wavelength-swept laser beam. The wavelength-swept light source 51 can be realized at low cost by, for example, applying a method of modulating a VCSEL (Vertical Cavity Surface Emitting Laser) with current since mode hopping is unlikely to occur due to a short resonator length, and the wavelength can be easily varied.

The optical amplifier 52 amplifies the beam projected from the wavelength-swept light source 51. The optical amplifier 52 is an EDFA (erbium-doped fiber amplifier), for example, and may be an optical amplifier dedicated to 1550 nm, for example.

The isolator 53 is an optical element through which an incident light beam is unidirectionally transmitted, and may immediately follow the wavelength-swept light source 51 in order to prevent the effect of noise generated by return beams.

Thus, the light beam projected from the wavelength-swept light source 51 is amplified by the optical amplifier 52, passes through the isolator 53, and is split into beams proceeding to a main interferometer and a secondary interferometer by the optical coupler 54. For example, the optical coupler 54 may split the light beam into the beams proceeding to the main and secondary interferometers at a ratio of 90:10 to 99:1.

The light beam that is split and proceeds to the main interferometer is further split into a beam in a direction toward the measurement target T and a beam in a direction toward the second-stage optical coupler 54b by the first-stage optical coupler 54a.

The light beam that is split in the direction toward the measurement target T by the first-stage optical coupler 54a passes through the collimating lens 22a and the objective lens 21 from the leading end of an optical fiber cable in the sensor head 20, and is radiated toward the measurement target T. Then, a light beam reflected at a reference surface, which is the leading end (end face) of the optical fiber cable, interferes with a light beam reflected at the measurement target T, and an interference beam is generated. The generated interference beam returns to the first-stage optical coupler 54a, and is thereafter received by the light-receiving element 56a and converted into an electrical signal.

The light beam that is split in the direction toward the second-stage optical coupler 54b by the first-stage optical coupler 54a proceeds toward the second-stage optical coupler 54b via the isolator 53a, and is further split in a direction toward the sensor head 20 by the second-stage optical coupler 54b. The light beam that is split in the direction toward the sensor head 20 passes through the collimating lens 22b and the objective lens 21 from the leading end of an optical fiber cable in the sensor head 20, as with the first stage, and is radiated toward the measurement target T. Then, a light beam reflected at a reference surface, which is the leading end (end face) of the optical fiber cable, interferes with a light beam reflected at the measurement target T, and an interference beam is generated. The generated interference beam returns to the second-stage optical coupler 54b, and is split into beams in a direction toward the isolator 53a and a direction toward the light-receiving element 56b by the optical coupler 54b. The light beam that is split in the direction toward the light-receiving element 56b is received by the light-receiving element 56b and converted into an electrical signal. Meanwhile, the isolator 53a is configured to transmit a light beam from the previous-stage optical coupler 54a toward the latter-stage optical coupler 54b and cut off a light beam from the latter-stage optical coupler 54b toward the previous-stage optical coupler 54a. Therefore, the beam split in the direction toward the isolator 53a is cut off.

The light beam that is split in the direction toward the third-stage optical coupler 54c by the second-stage optical coupler 54b proceeds toward the third-stage optical coupler 54c via the isolator 53b, and is further split in the direction toward the sensor head 20 by the third-stage optical coupler 54c. The light beam that is split in the direction toward the sensor head 20 passes through the collimating lens 22c and the objective lens 21 from the leading end of an optical fiber cable in the sensor head 20, as with the first and second stages, and is radiated toward the measurement target T. Then, a light beam reflected at the reference surface, which is the leading end (end face) of the optical fiber cable, interferes with a light beam reflected at the measurement target T, and an interference beam is generated. The generated interference beam returns to the third-stage optical coupler 54c, and is split into beams in a direction toward the isolator 53b and a direction toward the light-receiving element 56c by the optical coupler 54c. The light beam that is split in the direction toward the light-receiving element 56c is received by the light-receiving element 56c and converted into an electrical signal. Meanwhile, the isolator 53b is configured to transmit a light beam from the previous-stage optical coupler 54b toward the latter-stage optical coupler 54c and cut off a light beam from the latter-stage optical coupler 54c toward the previous-stage optical coupler 54b. Therefore, the beam split in the direction toward the isolator 53b is cut off.

Note that the light beam that is split in a direction other than the direction toward the sensor head 20 by the third-stage optical coupler 54c is not used to measure the measurement target T. Therefore, it is favorable to attenuate the light beam with the attenuator 55, which is a terminator or the like, so as not to be reflected and returned.

Thus, the main interferometer is an interferometer that has three stages of optical paths (three channels) each having an optical path length difference that is twice (round trip) the distance from the leading end (end face) of the optical fiber cable of the sensor head 20 to the measurement target T, and three interference beams corresponding to respective optical path length differences are generated.

The light-receiving elements 56a to 56c receive the interference beams from the main interferometer and generate electrical signals in accordance with the amount of light of the light beams received, as mentioned above.

The multiplexer circuit 57 multiplexes the electrical signals output from the light-receiving elements 56a to 56c.

The AD conversion unit 58 receives the electrical signal from the multiplexer circuit 57 and converts the electrical signal from an analog signal to a digital signal (AD conversion). Here, the AD conversion unit 58 performs AD conversion based on a correction signal from the correction signal generation unit 61 of the secondary interferometer.

The secondary interferometer obtains the interference signal in order to correct wavelength nonlinearities during the sweep with the wavelength-swept light source 51, and generates a correction signal called a K-clock.

Specifically, the light beam that is split and proceeds to the secondary interferometer by the optical coupler 54 is further split by the optical coupler 54d. Here, the optical paths of the split light beams are configured to have an optical path length difference using optical fiber cables with different lengths between the optical couplers 54d and 54e, and an interference beam corresponding to the optical path length difference is output from the optical coupler 54e, for example. The balance detector 60 receives the interference beam from the optical coupler 54e, and amplifies the optical signal and converts it to an electrical signal while removing noise by taking a difference from a signal of the opposite phase.

Note that the optical coupler 54d and the optical coupler 54e may split the light beam at a ratio of 50:50.

The correction signal generation unit 61 ascertains the wavelength nonlinearities during the sweep with the wavelength-swept light source 51 based on the electrical signal from the balance detector 60, generates a K-clock corresponding to the nonlinearities, and outputs the generated K-clock to the AD conversion unit 58.

Due to the wavelength nonlinearities during the sweep with the wavelength-swept light source 51, the wave intervals of the analog signal input to the AD conversion unit 58 from the main interferometer are not equal. The AD conversion unit 58 performs AD conversion (sampling) while correcting the sampling time based on the aforementioned K-clock so that the wave intervals are equal intervals.

Note that the K-clock is a correction signal used to sample the analog signal of the main interferometer, as mentioned above. Therefore, the K-clock needs to be generated so as to have a higher frequency than the analog signal of the main interferometer. Specifically, the optical path length difference provided between the optical coupler 54d and the optical coupler 54e in the secondary interferometer may be longer than optical path length differences between the leading ends (end faces) of the optical fiber cables in the main interferometer and the measurement target T. Alternatively, the correction signal generation unit 61 may increase the frequency by multiplication (e.g., by a factor of 8, etc.).

The processor 59 obtains the digital signal that has been subjected to AD conversion with its nonlinearities corrected by the AD conversion unit 58, and calculates displacement of the measurement target T (distance to the measurement target T) based on the digital signal. Specifically, the processor 59 performs frequency conversion on the digital signal using fast Fourier transform (FFT), and calculates the distance by analyzing them. The details of processing at the processor 59 will be described later.

Note that the processor 59 is required to perform high-speed processing, and is therefore realized by an integrated circuit such as an FPGA (field-programmable gate array) in many cases.

Here, the multiplexer circuit 57 is arranged on the upstream side of the AD conversion unit 58, but may alternatively be arranged on the downstream side of the AD conversion unit 58. The output from the plurality of light-receiving elements 56a to 56c may be separately subjected to AD conversion and then multiplexed by the multiplexer circuit 57.

Also, here, three stages of optical paths are provided in the main interferometer. The sensor head 20 radiates measurement beams from the respective optical paths toward the measurement target T, and the distance to the measurement target T, for example, is measured based on interference beams (return beams) obtained from the respective optical paths (multichannel). The number of channels in the main interferometer is not limited to three, and may alternatively be one or two, or may be four or more.

FIG. 5B is a diagram illustrating another principle by which a displacement sensor 10 according to the present disclosure may measure the measurement target T. As shown in FIG. 5B, the displacement sensor 10 includes a sensor head 20 and a controller 30. The sensor head 20 includes an objective lens 21 and a plurality of collimating lenses 22a to 22c. The controller 30 includes a wavelength-swept light source 51, an optical amplifier 52, a plurality of isolators 53, 53a and 53b, a plurality of optical couplers 54 and 54a to 54j, an attenuator 55, a plurality of light-receiving elements (e.g., photodetectors (PD)) 56a to 56c, a multiplexer circuit 57, an analog-to-digital (AD) conversion unit (e.g., analog-to-digital converter) 58, a processor (e.g., processor) 59, a balance detector 60, and a correction signal generation unit 61. The displacement sensor 10 shown in FIG. 5B has a configuration different from that of the displacement sensor 10 shown in FIG. 5A mainly in that the former has the optical couplers 54f to 54j. A principle of the different configuration will be described in detail in comparison with FIG. 5A. Each optical coupler 54, 54a to 54j has 2×2 (four) ports. A light beam input to a port at one end is output to two ports at the other end at a predetermined split ratio. Specifically, the first-stage optical coupler 54a has a first port, a second port, a third port, and a fourth port. A light beam input to the first port or the second port is output to the third port and the fourth port at a predetermined split ratio. A light beam input to the third port or the fourth port is output to the first port and the second port at a predetermined split ratio.

The light beam projected from the wavelength-swept light source 51 is amplified by the optical amplifier 52, and is split into a beam proceeding to the main interferometer side and a beam proceeding to the secondary interferometer side by the optical coupler 54 via the isolator 53. The light beam that is split and proceeds to the main interferometer side is further split into a measurement beam and a reference beam by the optical coupler 54f.

The measurement beam is caused to pass through the collimating lens 22a and the objective lens 21 by the first-stage coupler 54a and radiated to the measurement target T, and is reflected at the measurement target T, as described with reference to FIG. 5A. Here, in FIG. 5A, the light beam reflected at the reference surface, which is the leading end (end face) of an optical fiber cable, interferes with the light beam reflected at the measurement target T, and an interference beam is generated. Meanwhile, in FIG. 5B, the reference surface that reflects the light beam is not provided. In other words, in FIG. 5B, the light that is reflected at the reference surface as in FIG. 5A is not generated in FIG. 5B, and therefore, the measurement beam reflected at the measurement target T returns to the first-stage optical coupler 54a.

Similarly, the light beam that is split in the direction toward the second-stage optical coupler 54b from the first-stage optical coupler 54a is caused to pass through the collimating lens 22b and the objective lens 21 by the second-stage optical coupler 54b and radiated toward the measurement target T, and is reflected at the measurement target T and returns to the second-stage optical coupler 54b. The light beam that is split in the direction toward the third-stage optical coupler 54c from the second-stage optical coupler 54b is caused to pass through the collimating lens 22c and the objective lens 21 by the third-stage optical coupler 54c and radiated toward the measurement target T, and is reflected at the measurement target T and returns to the third-stage optical coupler 54c.

Meanwhile, the reference beam split by the optical coupler 54f is further split into beams proceeding to the optical couplers 54h, 54i, and 54j by the optical coupler 54g.

In the optical coupler 54h, the measurement beam that has been reflected at the measurement target T and output from the optical coupler 54a interferes with the reference beam output from the optical coupler 54g, and an interference beam is generated. The generated interference beam is received by the light-receiving element 56a and converted into an electrical signal. In other words, a light beam is split into the measurement beam and the reference beam by the optical coupler 54f, an interference beam is generated in correspondence with the optical path length difference between the optical path of the measurement beam (an optical path in which the light beam from the optical coupler 54f is reflected at the measurement target T via the optical coupler 54a, the collimating lens 22a and the objective lens 21 and reaches the optical coupler 54h) and the optical path of the reference beam (an optical path in which the light beam from the optical coupler 54f reaches the optical coupler 54h via the optical coupler 54g). The generated interference beam is received by the light-receiving element 56a and converted into an electrical signal.

Similarly, in the optical coupler 54i, an interference beam is generated in correspondence with the optical path length difference between the optical path of the measurement beam (an optical path in which the light beam from the optical coupler 54f is reflected at the measurement target T via the optical couplers 54a and 54b, the collimating lens 22b, and the objective lens 21 and reaches the optical coupler 54i) and the optical path of the reference beam (an optical path in which the light beam from the optical coupler 54f reaches the optical coupler 54i via the optical coupler 54g). The generated interference beam is received by the light-receiving element 56b and converted into an electrical signal.

In the optical coupler 54j, an interference beam is generated in correspondence with the optical path length difference between the optical path of the measurement beam (an optical path in which the light beam from the optical coupler 54f is reflected at the measurement target T via the optical couplers 54a, 54b, and 54c, the collimating lens 22c, and the objective lens 21 and reaches the optical coupler 54j) and the optical path of the reference beam (an optical path in which the light beam from the optical coupler 54f reaches the optical coupler 54j via the optical coupler 54g). The generated interference beam is received by the light-receiving element 56c and converted into an electrical signal. Note that the light-receiving elements 56a to 56c may be balance photodetectors, for example.

Thus, the main interferometer has three stages of optical paths (three channels), and generates three interference beams corresponding to the respective optical path length differences between the measurement beams that are reflected at the measurement target T and input to the optical couplers 54h, 54i, and 54j and the reference beams that are input to the optical couplers 54h, 54i, and 54j via the optical couplers 54f and 54g.

Note that the optical path length difference between a measurement beam and a reference beam may also be set so as to be different among the three channels. For example, the optical path lengths from the optical coupler 54g may be different among the optical couplers 54h, 54i, and 54j.

The distance to the measurement target T or the like is measured based on the interference beams obtained from respective optical paths (multichannel).

### Configuration of Sensor Head

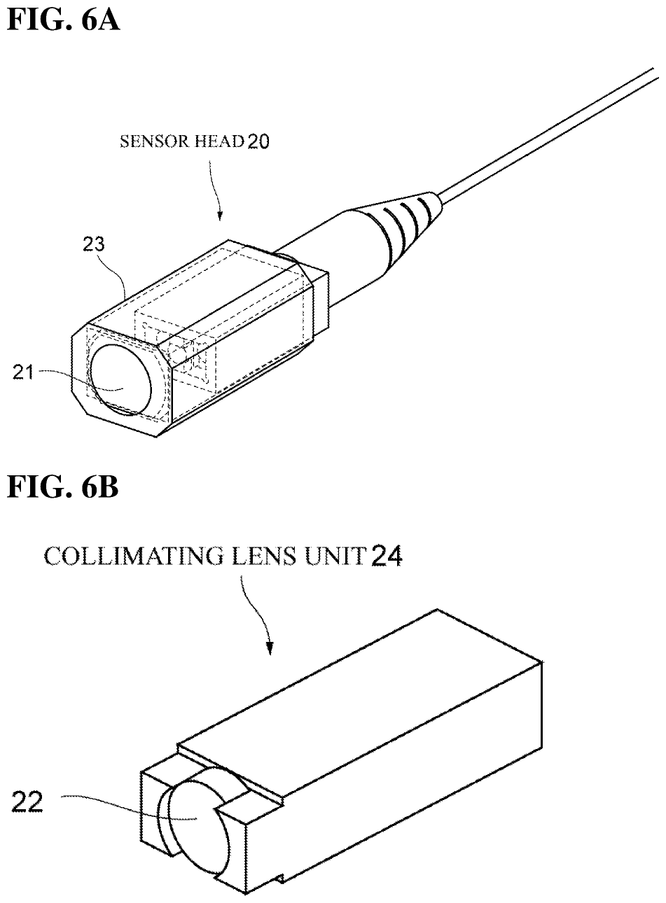

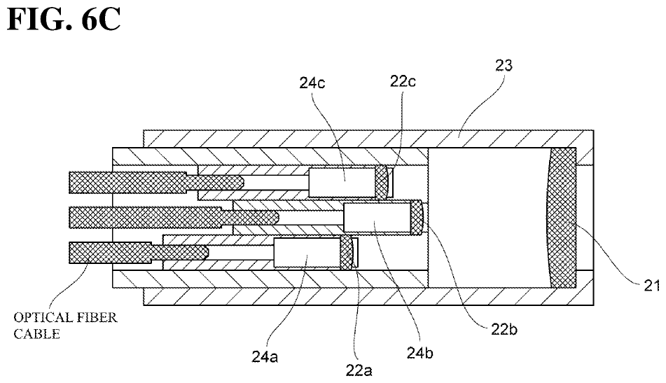

Here, a structure of the sensor head used in the displacement sensor 10 will be described. FIG. 6A is a perspective view showing a schematic configuration of the sensor head 20. FIG. 6B is a perspective view of a schematic configuration of a collimating lens holder arranged within the sensor head 20. FIG. 6C is a cross-sectional view of an internal structure of the sensor head.

In the sensor head 20, the objective lens 21 and the collimating lenses are accommodated in an objective lens holder 23, as shown in FIG. 6A. For example, the individual sides of the objective lens holder 23 that surround the objective lens 21 are about 10 mm long, and the objective lens holder 23 is about 22 mm in length in the optical axis direction.

As shown in FIG. 6B, a collimating lens unit 24 is formed by adhering a collimating lens 22 to the collimating lens holder using an adhesive material. The spot diameter can be adjusted by inserting an optical fiber cable, in accordance with the amount of insertion. The diameter of each collimating lens 22 is about 2 mm, for example.

Three collimating lenses 22a to 22c are held by the collimating lens holder, constituting collimating lens units 24a to 24c, and three optical fiber cables are inserted into the respective collimating lens units 24a to 24c in correspondence with the three collimating lenses 22a to 22c, as shown in FIG. 6C. Note that the three optical fiber cables may alternatively be held by the collimating lens holder.

These optical fiber cables and the collimating lens units 24a to 24c are held together with the objective lens 21 by the objective lens holder 23 and constitute the sensor head 20.

Here, the three collimating lens units are shifted with respect to each other so as to form different optical path length differences in terms of their positions in the optical axis direction in the sensor head 20, as shown in FIG. 6C.

The objective lens holder 23 and the collimating lens units 24a to 24c that constitute the sensor head 20 may be made of a metal (e.g., A2017) that has high strength and can be processed with high accuracy.

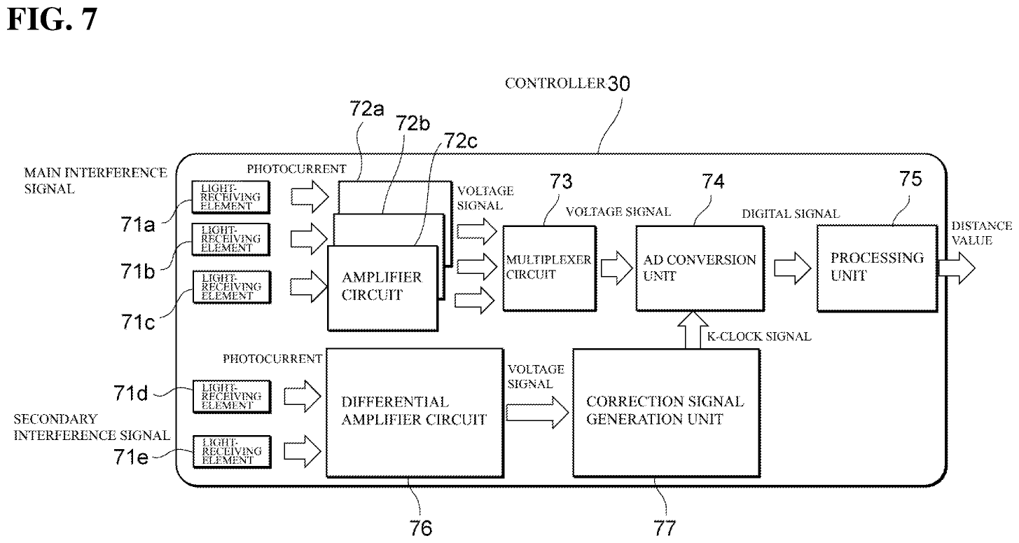

FIG. 7 is a block diagram illustrating signal processing in the controller 30. As shown in FIG. 7, the controller 30 includes a plurality of light-receiving elements 71a to 71e, a plurality of amplifier circuits 72a to 72c, a multiplexer circuit 73, an AD conversion unit 74, a processor 75, a differential amplifier circuit 76, and a correction signal generation unit 77.

In the controller 30, the light beam projected from the wavelength-swept light source 51 is split into a beam proceeding to the main interferometer and a beam proceeding to the secondary interferometer by the optical coupler 54, and the value of the distance to the measurement target T is calculated by processing main interference signals and secondary interference signals obtained respectively from the main and secondary interferometers, as illustrated in FIG. 5A.

The plurality of light-receiving elements 71a to 71c correspond to the light-receiving elements 56a to 56c shown in FIG. 5A, receive the main interference signals from the main interferometer, and output the received signals as current signals to the amplifier circuits 72a to 72c, respectively.

The plurality of amplifier circuits 72a to 72c convert the current signals to voltage signals (I-V conversion) and amplify these signals.

The multiplexer circuit 73 multiplexes the voltage signals output from the amplifier circuits 72a to 72c and outputs the multiplexed signal as one voltage signal to the AD conversion unit 74.

The AD conversion unit 74 corresponds to the AD conversion unit 58 shown in FIG. 5A, and converts the voltage signal to a digital signal (AD conversion) based on a K-clock from the later-described correction signal generation unit 77.

The processor 75 corresponds to the processor 59 shown in FIG. 5A, converts the digital signal from the AD conversion unit 74 to a frequency by means of FFT, analyzes the frequency, and calculates the value of the distance to the measurement target T.

The plurality of light-receiving elements 71d to 71e and the differential amplifier circuit 76, which correspond to the balance detector 60 shown in FIG. 5A, receive interference beams in the secondary interferometer, output interference signals one of which has an inverted phase, and amplify the interference signals and convert these signals to a voltage signal while removing noise by taking a difference between the two signals.

The correction signal generation unit 77 corresponds to the correction signal generation unit 61 shown in FIG. 5A, binarizes the voltage signal using a comparator, generates a K-clock, and outputs the generated K-clock to the AD conversion unit 74. The K-clock needs to be generated so as to have a higher frequency than the analog signal of the main interferometer. Therefore, the correction signal generation unit 77 may increase the frequency by multiplication (e.g., by a factor of 8 etc.).

Although the multiplexer circuit 73 in the controller 30 shown in FIG. 7 is arranged on the upstream side of the AD conversion unit 74, it may alternatively be arranged on the downstream side of the AD conversion unit 74. The output from the plurality of light-receiving elements 71a to 71c and the plurality of amplifier circuits 72a to 72c may be subjected to AD conversion, and may thereafter be multiplexed by the multiplexer circuit 73.

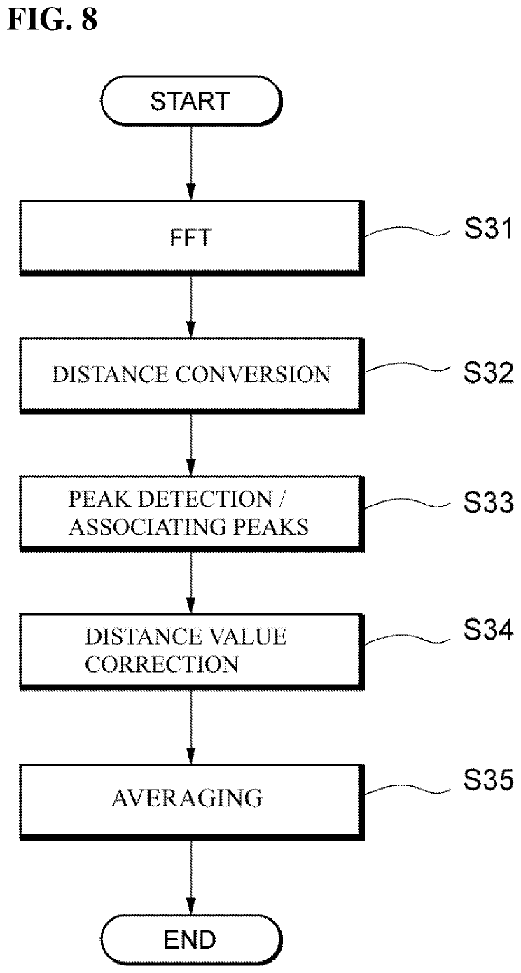

FIG. 8 is a flowchart showing a method for calculating the distance to the measurement target T that is executed by the processor 59 in the controller 30. The illustrated method includes steps S31 to S35, as shown in FIG. 8.

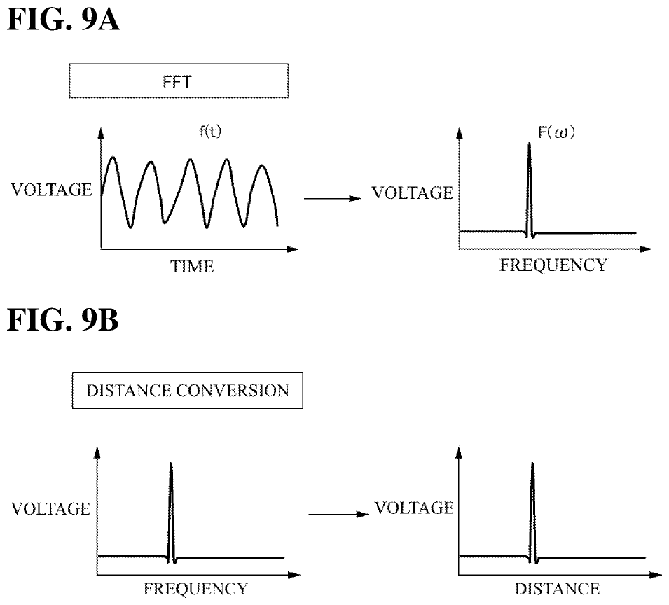

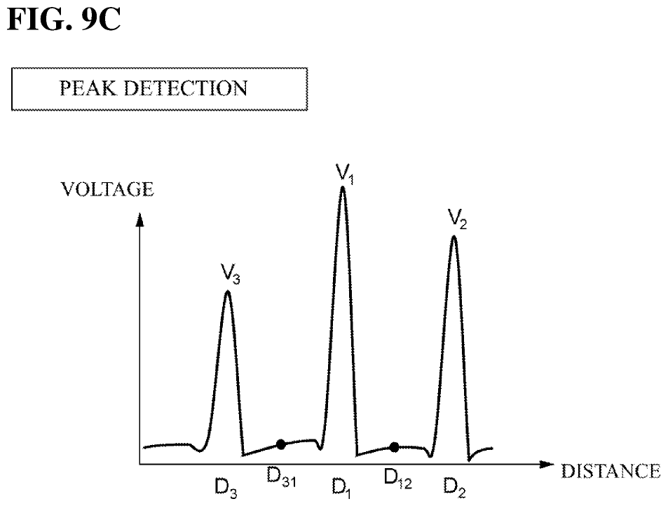

In step S31, the processor 59 performs frequency conversion on a waveform signal (voltage vs time) into a spectrum (voltage vs frequency) by means of a Fast Fourier Transform (FFT), such as is shown in the following Equation 1. FIG. 9A shows how the waveform signal (voltage vs time) is subjected to frequency conversion into the spectrum (voltage vs frequency).

$${\sum }_{t = 0}^{N - 1} f ( t ) exp ( - i \frac{2 πω t}{N} ) = F ( ω ) \qquad ( Equation 1 )$$

where N=number of data points

In step S32, the processor 59 performs distance conversion on the spectrum (voltage vs frequency) into a spectrum (voltage vs distance). FIG. 9B shows how the spectrum (voltage vs frequency) is subjected to distance conversion into the spectrum (voltage vs distance).

In step S33, the processor 59 calculates values (distance value, SNR) corresponding to peaks based on the spectrum (voltage vs distance). FIG. 9C shows how the values (distance, SNR) corresponding to peaks are calculated based on the spectrum (voltage vs distance).

(1) Peak values of voltage are calculated. Specifically, pairs (Dₓ, Vₓ) of a distance value and a voltage value at a distance at which the differential value of the voltage goes from positive to negative are created with respect to the voltage shown in FIG. 9C, and are arranged in descending order of the voltage value, i.e. (D₁, V₁), (D₂, V₂), (D₃, V₃), . . . , (Dₙ, Vₙ)

(2) Any combination with which the number of multiple heads is exceeded is excluded. For example, the displacement sensor 10 is provided with three stages of optical paths in the main interferometer, the sensor head 20 radiates measurement beams from the respective optical paths toward the measurement target T, and interference beams (return beams) obtained from the respective optical paths are received (the number of multiple heads=3), as shown in FIG. 5A. If there are four or more peaks, any peak in excess of three derives from noise, and may therefore be excluded from the calculation target. If the number of multiple heads is three, the pairs are (D₁, V₁), (D₂, V₂), and (D₂, V₂).

(3) The obtained pairs are rearranged in the order of distance. If the pairs are arranged in the ascending order of distance, they are arranged in the order of (D₂, V₂), (D₁, V₁), and (D₂, V₂).

(4) Peak-to-peak voltages are obtained. Specifically, a voltage V₃₁ at an intermediate distance D₃₁ between D₃ and D₁ is obtained, and a voltage V₁₂ at an intermediate distance D₁₂ between D₁ and D₂ is obtained. Then, an average voltage Vn of these voltages is calculated with an expression: Vn=(V₃₁+V₁₂)/2.

(5) Respective SNRs are calculated. Specifically, the following SNRs are obtained: SN₁=V₁/Vₙ, SN₂=V₂/Vₙ, and SN₃=V₃/Vₙ.

Thus, the values corresponding to the peaks are calculated as (distance value, SNR)=(D₁, SN₁), (D₂, SN₂), (D₃, SN₃) based on the spectrum (voltage vs. distance).

Returning to FIG. 8, in step S34, the processor 59 corrects the distance values out of the values (distance value, SNR) corresponding to the peaks that are calculated in step S33. Specifically, the three collimating lens units 24a to 24c (collimating lenses 22a to 22c and the optical fiber cables) are shifted from each other in terms of the position in the optical axis direction of the sensor head 20, as shown in FIG. 6C. Therefore, the distance values D₁, D₂, and D₃ corresponding to the respective peaks are corrected in accordance with the shift amounts (e.g., h₁, h₂, h₃ etc.).

As a result, the values corresponding to the peaks are calculated as (corrected distance value, SNR)=(D₁+h₁, SN₁), (D₂+h₂, SN₂), (D₃+h₃, SN₃).

In step S35, the processor 59 averages the distance values out of the values corresponding to the peaks (corrected distance value, SNR) that are calculated in step S34. Specifically, it is favorable that the processor 59 averages those corrected distance values with an SNR that has at least a threshold value out of the values (corrected distance value, SNR) corresponding to the peaks, and outputs the result of the averaging calculation as the distance to the measurement object T.

Next, a specific embodiment of the present disclosure will be described in detail, focusing on more characteristic configurations, functions, and properties. Note that the following optical interference range sensor corresponds to the displacement sensor 10 described with reference to FIGS. 1 to 9. Some or all of the basic configurations, functions, and properties included in the present optical interference range sensor are common to the configurations, functions, and properties included in the displacement sensor 10 described with reference to FIGS. 1 to 9.

### Embodiment

### Configuration of Optical Interference Range Sensor

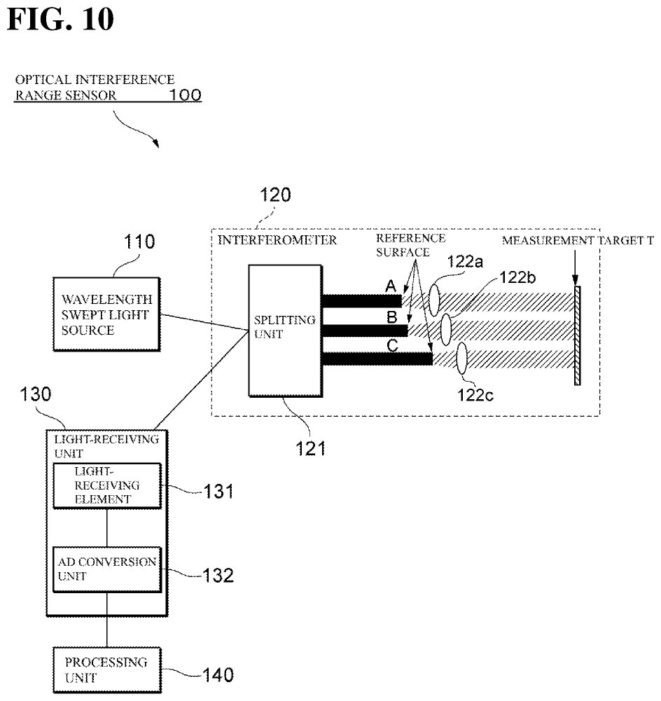

FIG. 10 is a schematic diagram showing a schematic configuration of an optical interference range sensor 100 according to one or more embodiments. As shown in FIG. 10, the optical interference range sensor 100 includes a wavelength-swept light source 100, an interferometer 120, a light-receiving unit 130, and a processor 140. The interferometer 120 includes a splitting unit 121, which splits an input light beam into a plurality of optical paths. Collimating lenses 122a to 122c are arranged in the respective optical paths. The light-receiving unit 130 includes a light-receiving element 131 and an AD conversion unit 132.

Note that some or all of the splitting unit 121 and the collimating lenses 122a to 122c that constitute the interferometer 120 may be accommodated in the same housing serving as a sensor head as shown in FIGS. 6A to 6C, for example. In the sensor head, an objective lens or lenses may be arranged in front of the collimating lenses 122a to 122c. The objective lens or lenses may be included in the same housing, or may be attached removably.

The wavelength-swept light source 110 is connected to the splitting unit 121 and projects a light beam while continuously varying the wavelength thereof.

The splitting unit 121 splits the input light beam projected from the wavelength-swept light source 110 into beams with optical paths A to C and outputs the split light beams so as to radiate these light beams toward a plurality of (here, three) spots on the measurement target T. The splitting unit 121 may be an optical coupler or the like, for example.

The light beam that is split into the optical path A serves as a measurement beam, passes through the collimating lens 122a via an optical fiber cable, and is radiated toward the measurement target T and reflected at the measurement target T. The reflected beam (first reflected beam) that has been reflected at the measurement target T returns to the splitting unit 121 from the leading end of the optical fiber through the collimating lens 122a.

Also, the light beam that is split into the optical path A serves as a measurement beam and is radiated toward the measurement target T via an optical fiber cable, but a part of the light beam serves as a reference beam and is reflected at a reference surface. Here, the leading end of the optical fiber cable serves as the reference surface, and the reflected beam (second reflected beam) reflected at the reference surface returns to the splitting unit 121 via the optical fiber cable.

Here, regarding the light beams output from the splitting unit 121 to the optical fiber cable in the optical path A, the measurement beam is radiated toward the measurement target T and returns as the first reflected beam to the splitting unit 121 via the optical fiber cable, and the reference beam returns as the second reflected beam, which is reflected at the reference surface that is the leading end of the optical fiber cable, to the splitting unit 121 via the optical fiber cable. Therefore, an interference beam is generated in accordance with an optical path length difference between the measurement beam and the reference beam. In other words, the optical path length difference is the round-trip distance from the leading end of the optical fiber cable in the optical path A to the measurement target T. The interferometer 120 generates an interference beam by interference between the first and second reflected beams, and the generated interference beam serves as a return beam to the splitting unit 121. Note that both the optical path lengths of the measurement beam and the reference beam may have values that are obtained by multiplying the spatial length of the optical path by a refractive index.

Similarly, the light beam that is split into the optical path B serves as a measurement beam, passes through the collimating lens 122b via an optical fiber cable, and is radiated toward the measurement target T and reflected at the measurement target T. The reflected beam (first reflected beam) that has been reflected at the measurement target T returns to the splitting unit 121 from the leading end of the optical fiber through the collimating lens 122b. A part of the light beam that is split into the optical path B serves as a reference beam and is reflected at a reference surface that is the leading end of the optical fiber cable. The reflected beam (second reflected beam) reflected at the reference surface returns to the splitting unit 121 via the optical fiber cable.

Thus, an interference beam is generated in accordance with an optical path length difference between the measurement beam and the reference beam of the light beam output from the splitting unit 121 to the optical fiber cable in the optical path B. In other words, the optical path length difference is the round-trip distance from the leading end of the optical fiber cable in the optical path B to the measurement target T. The interferometer 120 generates an interference beam by interference between the first and second reflected beams, and the generated interference beam serves as a return beam to the split unit 121.

Similarly, the light beam that is split into the optical path C serves as a measurement beam, passes through the collimating lens 122c via an optical fiber cable, and is radiated toward the measurement target T and reflected at the measurement target T. The reflected beam (first reflected beam) that has been reflected at the measurement target T returns to the splitting unit 121 from the leading end of the optical fiber through the collimating lens 122c. A part of the light beam that is split into the optical path C serves as a reference beam and is reflected at a reference surface that is the leading end of the optical fiber cable. The reflected beam (second reflected beam) reflected at the reference surface returns to the splitting unit 121 via the optical fiber cable.

Thus, an interference beam is generated in accordance with an optical path length difference between the measurement beam and the reference beam of the light beam output from the splitting unit 121 to the optical fiber cable in the optical path C. In other words, the optical path length difference is the round-trip distance from the leading end of the optical fiber cable in the optical path C to the measurement target T. The interferometer 120 generates an interference beam by interference between the first and second reflected beams, and the generated interference beam serves as a return beam to the splitting unit 121.

Thus, the input light beam projected from the wavelength-swept light source 110 is split by the splitting unit 121. In the optical paths A to C of the split beams, interference beams are generated that depend on the optical path length differences between the measurement beams radiated toward the respective spots on the measurement target T and the reference beams reflected at the reference surfaces that are the leading ends of the respective optical fiber cables in the optical paths A to C. These interference beams are output as return beams to the light-receiving unit 130 by the interferometer 120.

Note that the optical path length difference between each measurement beam and a corresponding reference beam is set so as to be different among the three spots (corresponding to the respective optical paths A to C). The details of the optical path length difference will be described later.

The light-receiving unit 130 receives the return beams (interference beams) from the interferometer 120. The light-receiving element 131 in the light-receiving unit 130, which is a photodetector, for example, receives the return beams output from the interferometer 120, and converts the received beams to electrical signals. The AD conversion unit 132 converts these electrical signals from analog signals to digital signals.

Note that, here, the light-receiving unit 130 may be configured to receive, as a single light-receiving unit, the optical signals including the interference beams corresponding to the three spots (corresponding to the optical paths A to C) as the return beams from the interferometer 120, instead of receiving the interference beams with separate light-receiving sub-units. Accordingly, a simple configuration at low cost may be realized.

The processor 140 calculates the distance to the measurement target T based on the return beams received by the light-receiving unit 130. Specifically, the processor 140 calculates the distance to the measurement target T by detecting peaks of the return beams received by the light-receiving unit 130 and associating the detected peaks with the aforementioned spots (corresponding to the optical paths A to C). Also, for example, the processor 140 is a processor realized by an integrated circuit such as an FPGA, and may perform frequency conversion on the input digital signals by means of FFT and calculate the distance to the measurement target T based on the frequency conversion results.

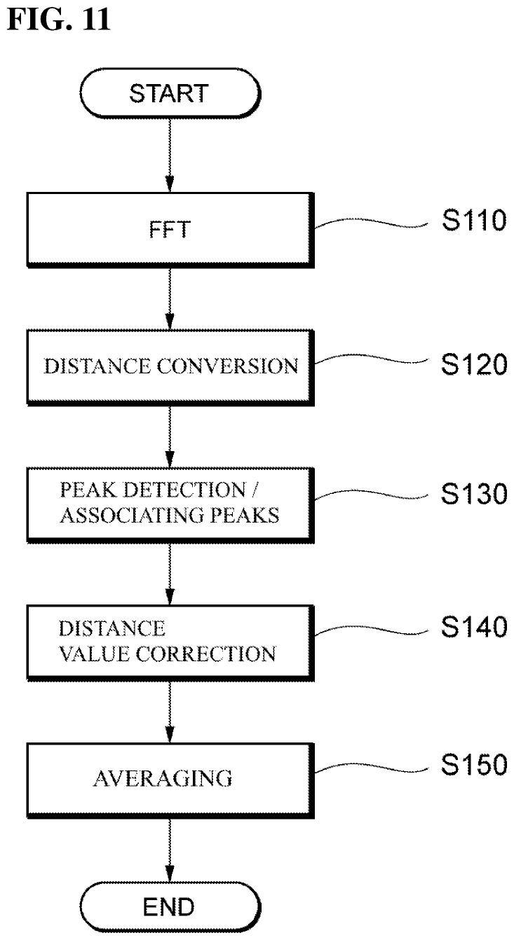

FIG. 11 is a flowchart illustrating a method for calculating the distance to the measurement target T that is executed by the processor 140. The illustrated method includes steps S110 to S150, as shown in FIG. 11.

In step S110, the processor 140 performs frequency conversion on a waveform signal from the light-receiving unit 130 by means of FFT, as in step S31 shown in FIG. 8, for example.

In step S120, the processor 120 performs distance conversion on the frequency spectrum, as in step S32 shown in FIG. 8, for example.

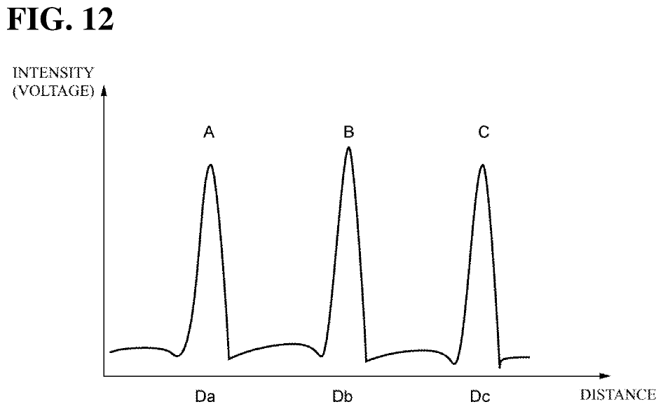

FIG. 12 schematically shows an example of a distance-converted signal waveform with respect to the returned beams received by the light receiving unit 130. As shown in FIG. 12, peaks corresponding to the three spots (corresponding to the optical paths A to C) appear in the return beams received by the light-receiving unit 130.

In step S130, the processor 140 associates a peak with a distance value Da with the spot corresponding to the optical path A, a peak with a distance value Db with the spot corresponding to the optical path B, and a peak with a distance value Dc with the spot corresponding to the optical path C, for example.

In step S140, the processor 140 corrects the distance values Da to Dc in accordance with the leading end positions of the optical fiber cables arranged in the respective optical paths A to C. As mentioned above, the optical paths A to C are set so that the optical path length difference between the measurement beam and the reference beam is different among the light beams split in correspondence with the three spots. As a result, the leading end positions of the optical fiber cables arranged in the optical paths A to C are shifted in position in the optical axis direction. Therefore, the processor 140 corrects the distance values Da to Dc based on the shift amount, and calculates the distance to the measurement target T. As for the leading end positions of the optical fiber cables, the collimating lens units into which the leading ends of the respective optical fiber cables are inserted may be shifted in terms of the position in the optical axis direction, as shown in FIG. 6C, for example.

Since the leading end positions of the optical fiber cables arranged in the optical paths A to C are thus shifted in the optical axis direction, the optical path length difference between the measurement beam and the reference beam is different among the optical paths A to C. The peaks of the return beams received by the light-receiving unit 130 that correspond to the three respective spots (corresponding to the optical paths A to C) appear in a shifted manner, and can therefore be detected appropriately.

Next, coherent FMCW (Frequency-Modulated Continuous Wave) will be described.

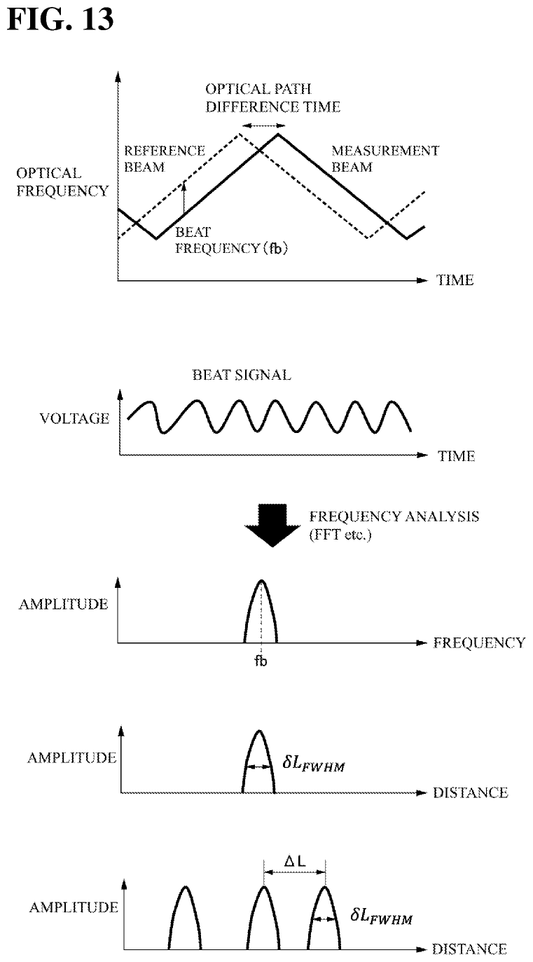

FIG. 13 is a diagram illustrating coherent FMCW. As mentioned above, the wavelength-swept light source 110 projects a light beam while continuously varying the wavelength (frequency). An interference beam is generated based on an optical path length difference between a measurement beam, which is radiated toward the measurement target T and reflected, and a reference beam, which is reflected at the reference surface that is the leading end of the optical fiber cable.

The light beam projected from the wavelength-swept light source 110 causes interference due to the measurement beam being delayed with respect to the reference beam by the optical path length difference, as shown in FIG. 13. Then, the light-receiving unit 130 receives the interference as a beat signal (interference beam) having a beat frequency, which is the difference in frequency between the measurement beam and the reference beam. The beat frequency fb is obtained by the following expression: fb=δf/T·2Ln/c (δf: frequency sweep width, T: sweep time, L: optical path difference, n: refractive index in optical path difference, c: speed of light).

Furthermore, the processor 140 performs frequency analysis by means of FFT, and therefore a distance to the measurement target T appears as a peak in the signal waveform, as mentioned above. The clarity with which the peak waveform appears depends on the distance resolution. The distance resolution δL_{FWHM} is obtained by the following expression: δL_{FWHM}=c/nδf (c: speed of light, n: refractive index in optical path difference, δf: frequency sweep width).

In other words, by increasing the frequency sweep width δf, the distance resolution δL_{FWHM} can be reduced, and the half-width of the peak waveform can be reduced so that the peak appears more clearly. As a result, the distance to the measurement target T can be calculated with higher accuracy.

If a plurality of peaks appear in the signal waveform as in the present embodiment, the difference ΔL in the optical path length difference between the measurement beam and the reference beam in each of the optical paths A to C is favorably greater than the distance resolution δL_{FWHM} in order to cause the peaks to appear clearly and appropriately detect the peaks.

In step S150, the processor 140 averages the corrected distance values based on the shift amounts of the optical fiber cables corresponding to the peaks calculated in step S140, as in step S35 shown in FIG. 8, and uses the calculated average as the distance to the measurement target T.

### Processing Performed While Giving Consideration to Disappearance of Peaks

As described above, the optical interference range sensor 100 is configured to appropriately measure the distance to the measurement target T by causing the peaks of the return beams received by the light-receiving unit 130 that correspond to the three spots (corresponding to the optical paths A to C) to appear clearly. However, there are cases where the peaks disappear due to the surface shape of the measurement target T, noise coming from the surrounding environment, or the like.

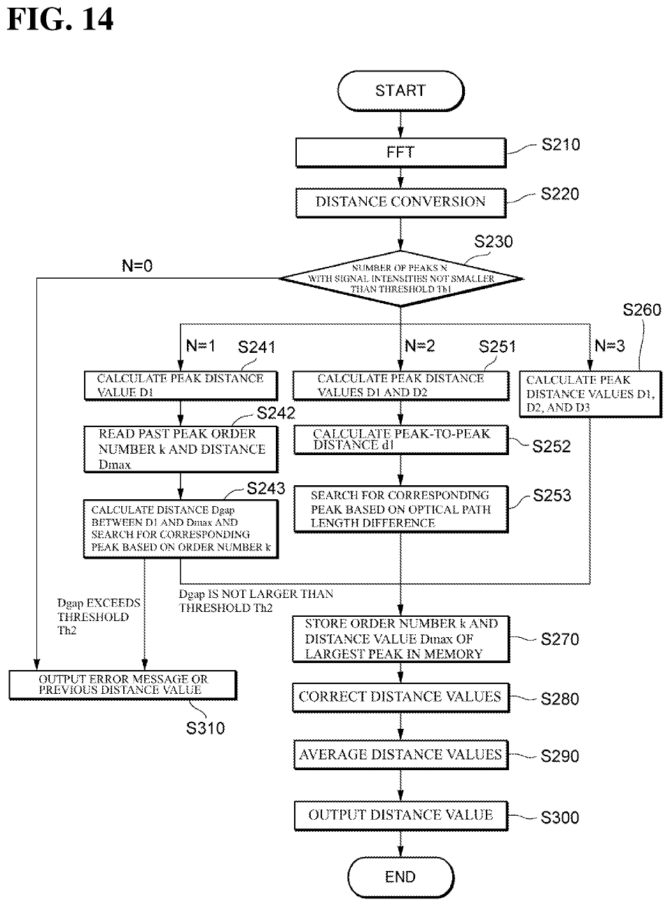

FIG. 14 is a flowchart showing a method for calculating the distance to the measurement target T while giving consideration to the case where peaks of the return beams received by the light receiving unit 130 disappear. The illustrated method includes steps S210 to S310.

Steps S210 and S220 are the same as steps S110 and S120 described with reference to FIG. 11.

In step S230, the processor 140 detects peaks based on a signal obtained by performing distance conversion on the return beams received by the light-receiving unit 130 to a spectrum (voltage vs distance), and determines the number of peaks N. For example, the number of peaks having a signal intensity that is not smaller than a predetermined threshold Th1 may be detected.

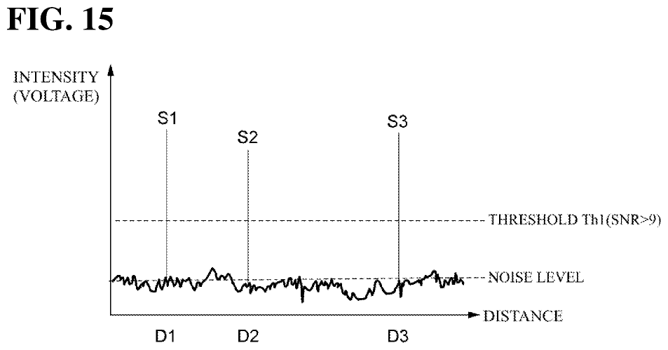

FIG. 15 schematically shows how peaks are detected based on a signal that is subjected to distance conversion into a spectrum (voltage vs distance). As shown in FIG. 15, the processor 140 detects S1, S2, and S3 with signal intensities that are not smaller than the threshold Th1 as peaks. In such a case, the processor 140 may determine the number of peaks to be three.

Note that, here, the threshold Th1 may be preset, or may vary dynamically. For example, an SNR may be calculated for each peak after estimating the noise between the peaks, and the number of peaks with signal intensities exceeding the predetermined threshold Th1 (e.g., SNR>9) may be determined.

If the predetermined threshold Th1 is set to vary dynamically, for example, the noise level can be ascertained depending on the situations and the number of peaks included in the return beams can be appropriately detected even if the amount of light of the return beams received by the light-receiving unit 130 has changed due to, for example, a change in the type of the measurement target T or the surrounding environment.

In the present embodiment, consideration will be given to the cases where the number of detected peaks N is “0: three peaks have disappeared”, “1: two peaks have disappeared”, “2: one peak has disappeared”, and “3: no peak has disappeared”, with respect to the peaks corresponding to the three spots (corresponding to the optical paths A to C).

Returning to FIG. 14, if, in step S230, the number of peaks N is 0, the processing advances to step S310. In step S310, the processor 140 outputs an error message, or the previously calculated distance value. As a specific example, the processor 140 cannot calculate the distance to the measurement target T if no peak can be detected. In such a case, the processor 140 may display an error message in the display unit 31 in the controller 30, for example. Alternatively, the processor 140 may display the previously calculated distance value instead of, or in addition to, a display of an error message.

If, in step S230, the number of peaks N is 1, the processing advances to step S241. In step S241, the processor 140 calculates, for the one detected peak, a distance value D1 based on the peak.

In step S242, the processor 140 reads information regarding peaks detected in the past. Specifically, information regarding the largest peaks out of detected peaks of return beams received in the past by the light-receiving unit 130 is stored in the memory. For example, the processor 140 reads, from the memory, the order numbers k of the largest peaks corresponding to the respective optical paths A to C split by the splitting unit 121, and the distance values Dmax corresponding to the largest peaks.

In step S243, the processor 140 compares the distance value D1 calculated in step S241 with the distance values Dmax corresponding to the order numbers k (spots corresponding to the optical paths A to C), and determines to which order number k (spot corresponding to one of the optical paths A to C) the distance value D₁ corresponds. Specifically, the processor 140 calculates a difference Dgap between the distance value D1 and each of the distance values Dmax corresponding to the respective order numbers k (spots corresponding to the respective optical paths A to C). If the difference Dgap is not larger than a predetermined threshold Th2 (within a range), the processor 140 determines that the distance value D1 corresponds to the order number k (one of the spots corresponding to the optical paths A to C).

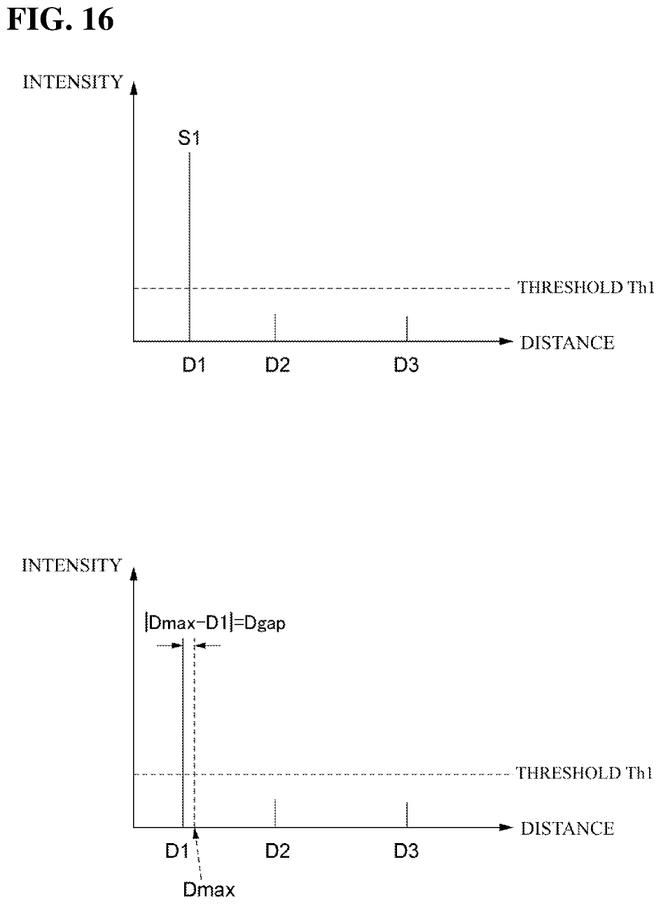

FIG. 16 shows how processing is executed in steps S241 to S243 based on only one detected peak S1. As shown in FIG. 16, two peaks have disappeared and only one peak S1 is detected. The distance value D1 based on the peak S1 is calculated (step S241). Dgap (|Dmax−D1|) is calculated by comparing the distance value D1 with the distance value Dmax corresponding to the order number k (spot corresponding to the one of the optical paths A to C) stored in the past.

For example, it is assumed here that the distance value D1 is close to the distance value Dmax with the order number k corresponding to the optical path A=1, and Dgap (|Dmax−D1|) is within the range of a predetermined threshold Th2. It can thus be determined that the distance value D1 corresponding to the peak S1 is a distance value corresponding to the peak based on the spot corresponding to the optical path A.

On the other hand, if Dgap (|Dmax−D1|) is not within the range of the predetermined threshold Th2, the distance value D1 corresponding to the detected peak S1 cannot be determined based on the distance value Dmax corresponding to the order numbers k (spots corresponding to the optical paths A to C) stored in the past. Accordingly, it is determined that an error has occurred, and the processing advances to step S310.

As described above, even if only one peak is detected, it may be possible to avoid a significant error in determining the distance value by comparing the distance value with information regarding the largest peaks stored among the peaks detected in the past.

Returning to FIG. 14, if, in step S230, the number of peaks N is 2, the processing advances to step S251. In step S251 the processor 140 calculates, for the two detected peaks, distance values D1 and D2 based on these peaks.

In step S252, the processor 140 calculates a peak-to-peak distance d1 between the distance values D1 and D2 based on the two peaks.

In step S253, the processor 140 determines the optical paths A to C to which the distance values D1 and D2 correspond, based on the peak-to-peak distance d1 calculated in step S252 and the optical path length differences in the optical paths A to C.

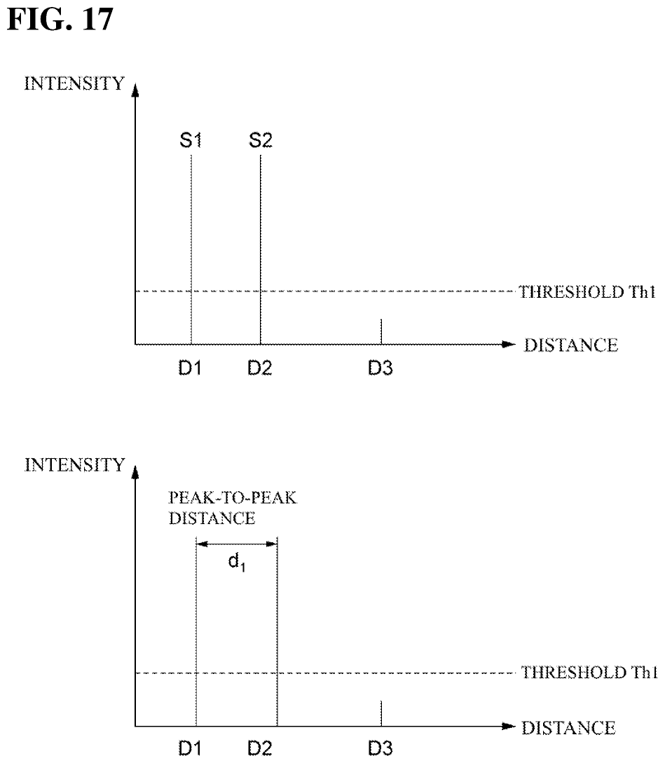

FIG. 17 shows how processing is executed in steps S251 to S253 based on two detected peaks S1 and S2. As shown in FIG. 17, one peak has disappeared and two peaks S1 and S2 are detected. The distance values D1 and D2 based on these peaks S1 and S2 are calculated (step S251). Then, the peak-to-peak distance d1 between the distance values D1 and D2 based on the two respective peaks is calculated (step S252).

Here, the respective optical path length differences are set so that which of the optical paths A to C the two peaks S1 and S2 correspond to can be determined based on the peak-to-peak distance d1. The peaks corresponding to the three spots (corresponding to the optical paths A to C) appear while being shifted from each other due to the optical path length difference between the measurement beam and the reference beam being made different among the optical paths A to C, as described with reference to FIGS. 12 and 13. The relationship between the peak-to-peak distance and peaks corresponding to the three respective spots (corresponding to the optical paths A to C) will be described in detail below.

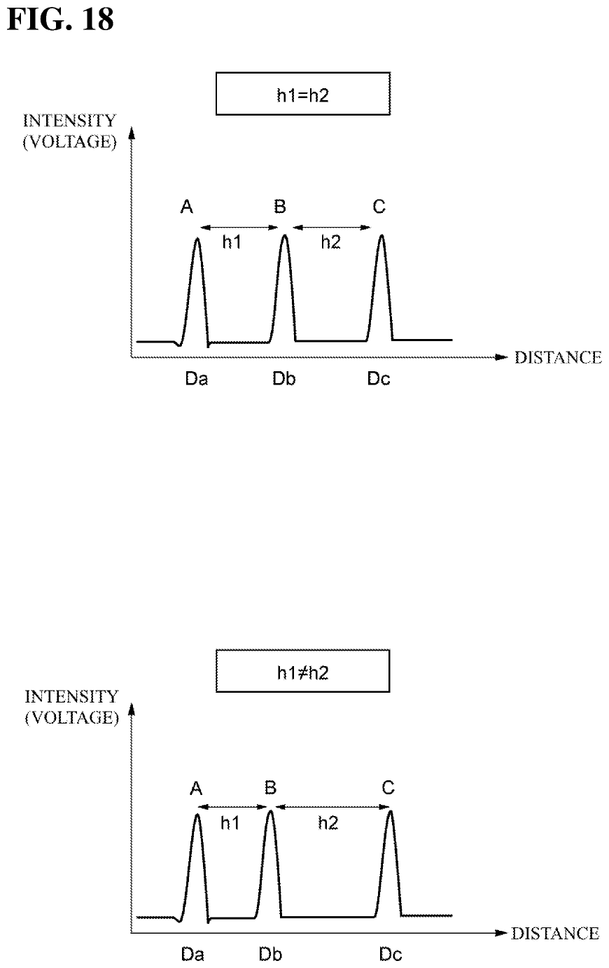

FIG. 18 is a diagram illustrating the relationship between the peak-to-peak distance and the peaks corresponding to three respective spots (which correspond to the optical paths A to C). FIG. 18 shows a peak-to-peak distance h1 between the peaks A and B and a peak-to-peak distance h2 between the peaks B and C, for the peaks corresponding to the three respective spots (corresponding to the optical paths A to C).

When the leading end positions of the optical fiber cables in the optical paths A to C are arranged so that the optical path length difference is different among the optical paths A to C and h1≠h2, if, for example, one peak has disappeared and the peak-to-peak distance between the two detected peaks is h1, it can be determined that the peak C has disappeared and the peaks A and B have been detected. If the peak-to-peak distance between the two detected peaks is h2, it can be determined that the peak A has disappeared and the peaks B and C have been detected. If the peak-to-peak distance between the two detected peaks is h1+h2, it can be determined that the peak B has disappeared and that the peaks A and C have been detected.

In contrast, when the leading end positions of the optical fiber cables in the optical paths A to C are arranged so that the optical path length difference is different among the optical paths A to C and h1=h2, if, for example, one peak has disappeared, it is difficult to determine, based on the peak-to-peak distance between the two detected peaks, which of the optical paths A to C the two detected peaks correspond to.

Thus, when one peak has disappeared and two peaks have been detected, it can be determined which of the optical paths A to C the two peaks correspond to if the leading end positions of the optical fiber cables are arranged in advance in the optical paths A to C so that the peak-to-peak distances calculated from the respective combinations of peaks are different (step S253).

When which of the optical paths A to C two peaks correspond to is determined based on the peak-to-peak distance between these two peaks, for example, a predetermined range may be allowed for the peak-to-peak distance. For example, it may be determined that the peak-to-peak distance between two peaks is h1 or h2, which are preset, if it is in the range of ±10% from h1 or h2. However, in such a case, the leading end positions of the optical fiber cables are arranged in advance in the optical paths A to C so that 0.9*h2−1.1*h1>0 is satisfied and the allowable ranges for h1 and h2 do not overlap.

Returning to FIG. 14, if, in step S230, the number of peaks N is 3, the processing advances to step S260. In step S260, the processor 140 calculates, for the three detected peaks, distance values D1, D2, and D3 based on these peaks.

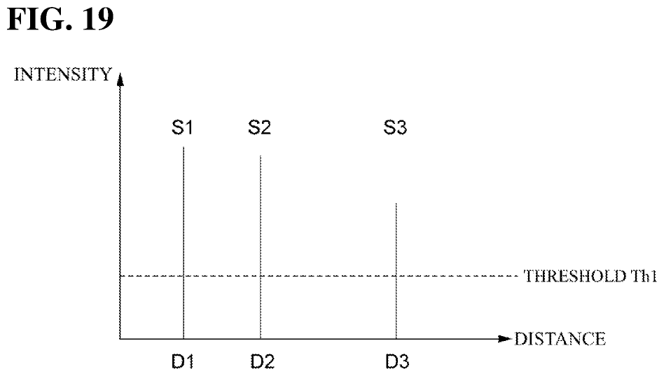

FIG. 19 shows how processing is executed in steps S260 based on the three detected peaks S1, S2, and S3. As shown in FIG. 19, no peak has disappeared here and three peaks S1, S2, and S3 are detected, and the distance values D1, D2, and D3 based on these peaks S1, S2, and S3 are calculated.

Returning to FIG. 14, in step S270, the processor 140 stores, in the memory, information regarding the largest peak out of the detected peaks of the return beams received by the light-receiving unit 130. Specifically, if, for example, one peak has been detected, the processor 140 stores, in the memory, the order number k (order number indicating one of the optical paths A to C) corresponding to the peak and the distance value Dmax thereof. If two or three peaks have been detected, the processor 140 stores, in the memory, the order number k (order number indicating one of the optical paths A to C) corresponding to the largest peak out of the detected peaks, and the distance value Dmax for the largest peak. The order number k indicating one of the optical paths A to C and the distance value Dmax for the order number k that are thus stored in the memory are used in the aforementioned steps S241 and S243 during the next and subsequent measurements.

In step S280, the processor 140 corrects the distance values corresponding to the peaks detected in step S243, S253, or S260 in accordance with the leading end positions of the optical fiber cables arranged in the optical paths A to C. Specifically, for example, since the leading end positions of the optical fiber cables arranged in the optical paths A to C are shifted in the optical axis direction, the processor 140 may correct the distance values corresponding to the peak detected in step S243, S253, or S260 based on the shift amounts, as in step S34 described with reference to FIG. 8 and in step S140 described with reference to FIG. 11.

In step S290, the processor 140 averages the distance values corrected in step S280.

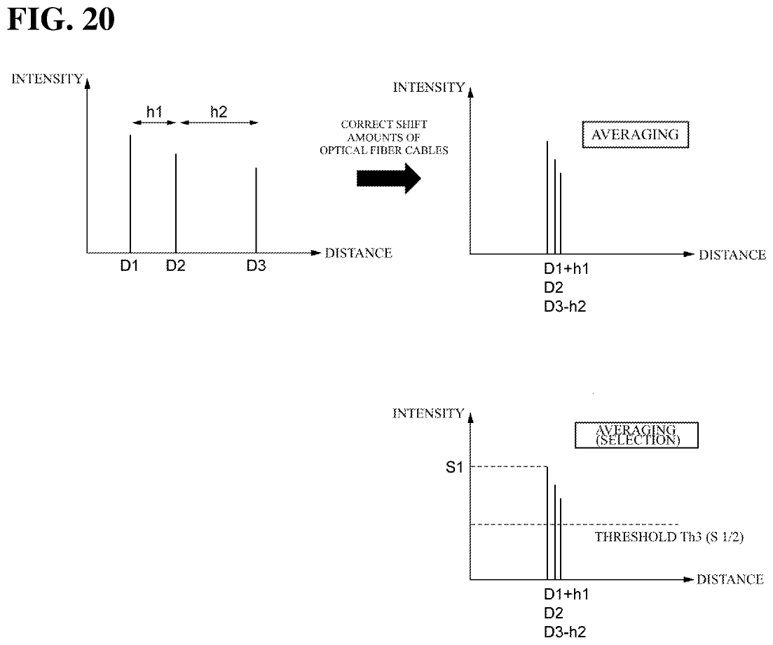

FIG. 20 shows how the distance values corresponding to the detected peaks are corrected based on the amounts of shift in the optical axis direction between the leading end positions of the optical fiber cables arranged in the optical paths A to C, and are then averaged. As shown in FIG. 20, when, for example, the leading end position of the optical fiber cable arranged in the optical path B serves as a reference, the distance values D1 and D3 based on the peaks corresponding to the optical paths A and C are corrected as D1+h1 and D3−h2, respectively, based on the reference distance value D2 based on the peak corresponding to the optical path B.

The processor 140 may then calculate the distance to the measurement target T by averaging D1+h1, D2, and D3−h2.

Further, the processor 140 may also select peaks having signal intensities that are not smaller than a predetermined threshold Th3 and average distance values corresponding to the selected peaks. For example, one half of S1, which is the largest signal intensity out of a plurality of peaks, may be set as the threshold Th3, and the distance to the measurement target T may be calculated by averaging distance values (here, D1+h1, D2, D3−h2) corresponding to the peaks having signal intensities that are not smaller than the threshold Th3. The distance to the measurement target T can be calculated with higher accuracy since only distance values corresponding to peaks with large signal intensities are to be averaged and distance values corresponding to peaks that are less reliable or not accurate are not applied.

In step S300, the processor 140 outputs the distance value averaged in step S290. For example, the processor 140 displays the distance to the measurement target T calculated in the step S290 in the display unit 31, and/or outputs the calculated distance to the control device 11, the externally connected device 13, or the like via the external I/F unit 33.

Note that, here, the processor 140 converts frequency to distance in step S220 immediately after step S210, and compares and calculates distance values in the subsequent steps. However, the distance conversion in step S220 need not be performed immediately after step S210. The processor 140 may alternatively compare and calculate frequency in step S210 or any subsequent step, for example, and may convert frequency to distance immediately before step S300. The same applies to the distance conversion (steps S32 and S120) shown in FIGS. 8 and 11.

As described above, according to the optical interference range sensor 100 of one or more embodiments, the interferometer 120 radiates light beams split in correspondence with three spots toward the measurement target T to generate interference beams by interference between measurement beams radiated toward the measurement target T and reflected at the measurement target T and reference beams passing through optical paths that are at least partially different from those of the measurement beams, and outputs the generated interference beams as return beams. The light-receiving unit 130 receives the return beams from the interferometer 120. The processor 140 detects peaks of the return beams, and calculates the distance to the measurement target T by associating the detected peaks with the spots. The optical path length difference between a measurement beam and a corresponding reference beam is made different among the light beams split in correspondence with the three spots. Therefore, the peaks can be appropriately detected, and the distance to the measurement target T can be calculated with high accuracy based on the distance values corresponding to the detected peaks. In other words, it may be possible to appropriately recognize the peaks corresponding to three spots (corresponding to the optical paths A to C) and measure the distance to the measurement target T with high accuracy based on the distance values corresponding to the peaks.

Furthermore, even when a peak signal is lost due to speckle, a detected peak can be appropriately determined by comparing the detected peak with information regarding the largest peak stored out of the peaks detected in the past, or by arranging the leading end positions of the optical fiber cables in the optical paths A to C and appropriately setting the peak-to-peak distances so that the optical path length difference is different among the optical paths A to C. As a result, the distance to the measurement target T can be measured with high accuracy.

Note that the splitting unit 121 in the present embodiment is configured to split a light beam from the wavelength-swept light source 110 into beams with three optical paths A to C and radiate measurement beams toward three spots on the measurement target T. However, there is no limitation thereto. For example, the number of optical paths split and the number of spots may be two, or may be four or more.

The optical interference range sensor 100 according to the present embodiment may also include an adjustment unit. Specifically, the optical interference range sensor 100 may include an adjustment unit for adjusting the amount of light of the return beams received by the light-receiving unit 130 shown in FIG. 10.

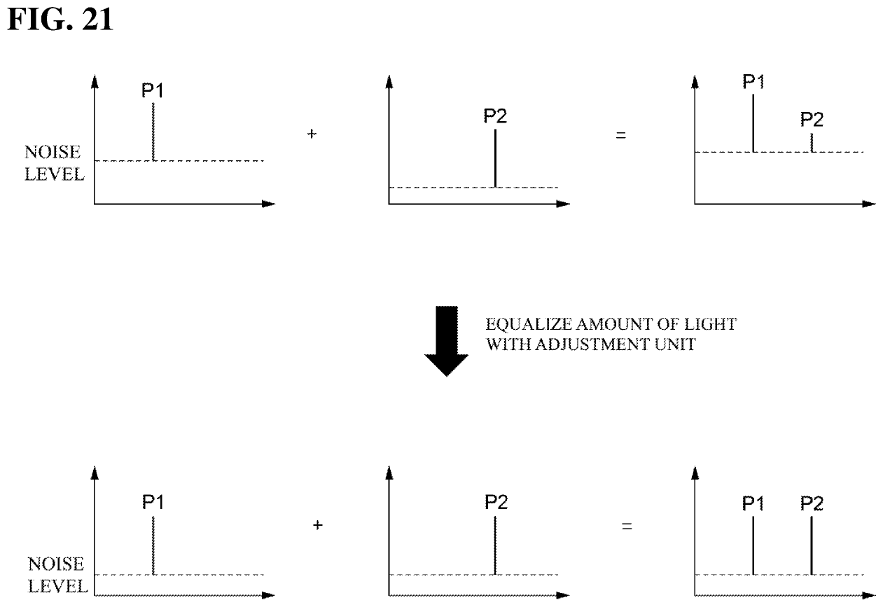

FIG. 21 is a diagram illustrating how the adjustment unit adjusts the amount of light of the received return beams. If, for example, there is a difference in the amount of light between the return beam from the optical path A and the return beam from the optical path B, as shown in FIG. 21, there is a possibility that peaks cannot be appropriately detected from the return beams received by the light-receiving unit 130, which is constituted by one light-receiving unit, due to noise of a peak with a large amount of light canceling the other peak.

Therefore, the adjustment unit is configured to enable appropriate detection of the peaks by equalizing the amount of light of the return beams from the respective optical paths.

The processor 140 of the optical interference range sensor 100 according to the present embodiment may also calculate the distance to the measurement target T by means of sub-pixel estimation. The processor 140 performs frequency conversion on the return beams received by the light-receiving unit 130 by means of FFT, and thereafter generates a signal waveform obtained by converting frequency-analyzed discrete values to distance by means of sub-pixel estimation when performing distance conversion.

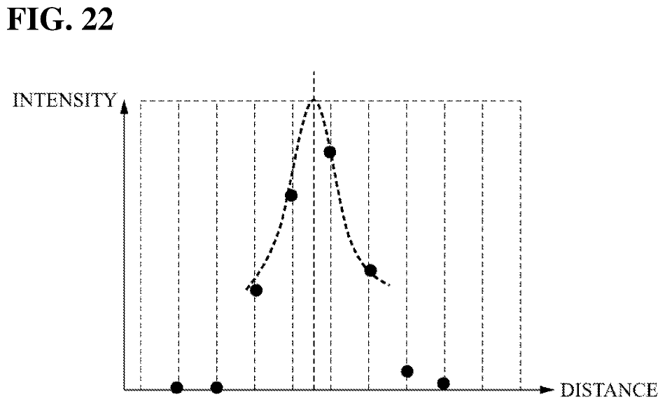

FIG. 22 shows how the signal waveform converted into distance is generated by means of sub-pixel estimation. As shown in FIG. 22, the signal waveform is generated by converting a plurality of discrete values into distance as continuous data while performing data interpolation by means of sub-pixel estimation.

Thus, a peak is detected based on the signal waveform that is appropriately converted into distance, and as a result, the distance to the measurement target T can be calculated with higher accuracy.

### Variation of Interferometer

The optical interference range sensor 100 in the above embodiment uses a Fizeau interferometer that generates an interference beam by using the leading end (end face) of the optical fiber cable in each of the optical paths A to C split by the splitting unit 121 as a reference surface (reference beam and reflected beam thereof). However, the interferometer is not limited thereto.

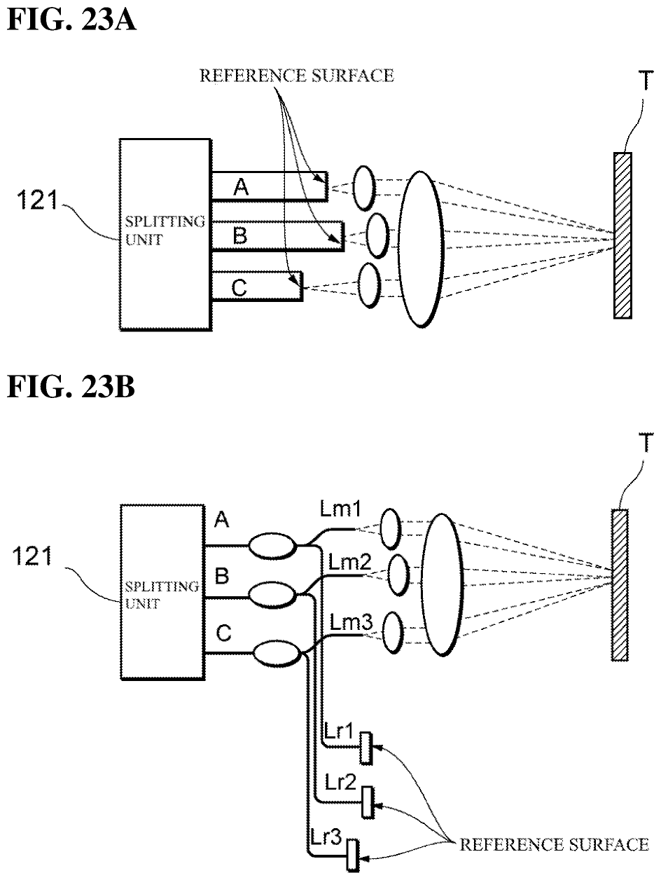

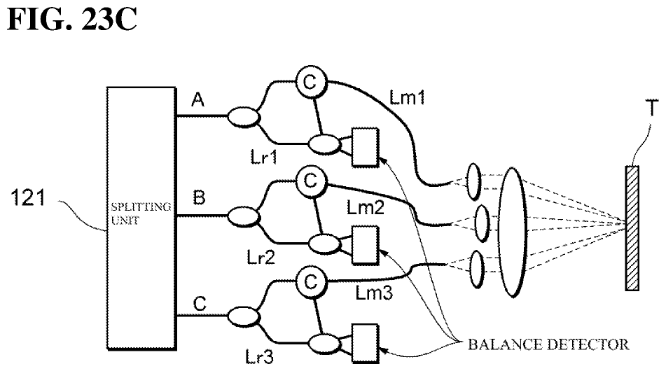

FIGS. 23A to 23C show variations of interferometers that generate an interference beam using a measurement beam and a reference beam. In FIG. 23A, the leading end positions of the optical fiber cables are shifted in the optical axis direction so that the optical path length difference is different among the optical paths A to C split by the splitting unit 121, while using the leading end (end face) of each optical fiber cable as a reference surface. Such may be the configuration of the interferometer 120 (Fizeau interferometer) of the optical interference range sensor 100 according to the above embodiment or other embodiments. The reference surface may alternatively be configured so that a light beam is reflected due to a difference in refractive index between the optical fiber cable and the air (Fresnel reflection). In addition, the leading end of each optical fiber may also be coated with a reflective film. Alternatively, a configuration may also be employed in which a non-reflective coating is applied to the leading end of each optical fiber, and a reflective surface, such as a lens surface, is arranged separately.

In FIG. 23B, measurement optical paths Lm1 to Lm3 for guiding measurement beams to the measurement target T and reference optical paths Lr1 to Lr3 for guiding reference beams are formed in the optical paths A to C split by the splitting unit 121. Reference surfaces are arranged at leading ends of the reference optical paths Lr1 to Lr3 (Michelson interferometer). The reference surfaces may be obtained by coating the leading ends of the optical fiber cables with reflective films, or may be obtained by applying non-reflective coating to the leading ends of the optical fibers and separately arranging reflective surfaces such as lens surfaces. In the above described configuration, the measurement optical paths Lm1 to Lm3 have the same optical path length, while the optical path length difference is provided between the reference optical paths Lr1 to Lr3, thereby making the optical path length difference different among the optical paths A to C. Optical design in the sensor head can be simplified since the optical path lengths of the measurement optical paths Lm1 to Lm3 can be made identical.

In FIG. 23C, measurement optical paths Lm1 to Lm3 for guiding measurement beams to the measurement target T and reference optical paths Lr1 to Lr3 for guiding reference beams are formed in the optical paths A to C split by the splitting unit 121. Balance detectors are arranged in the reference optical paths Lr1 to Lr3 (Mach-Zehnder interferometer). In the above described configuration, the measurement optical paths Lm1 to Lm3 have the same optical path length, while the optical path length difference is provided between the reference optical paths Lr1 to Lr3, thereby making the optical path length difference different among the optical paths A to C. Optical design in the sensor head can be simplified since the optical path lengths of the measurement optical paths Lm1 to Lm3 can be made identical.

Thus, the interferometer is not limited to the Fizeau interferometer described in the embodiment above, and may be, for example, a Michelson interferometer or a Mach-Zehnder interferometer. Any type of interferometer may be applied, or a combination of those interferometers or any other configuration may be applied if an interference beam can be generated by setting the optical path length difference between a measurement beam and a reference beam.

The optical interference range sensor described in the present embodiment can be used as a displacement sensor, a distance meter, a lidar, or the like for measuring the distance to the measurement target T.

The above-described embodiment is for facilitating the understanding of the invention, and is not intended to interpret the invention in a limiting manner. The elements provided by the embodiment, and the arrangements, materials, conditions, shapes, sizes, and the like of these elements are not limited to those described as examples, and may be modified as appropriate. The configurations described in different embodiments can be partially replaced or combined.

### Supplementary Notes

One or more embodiments may further include an optical interference range sensor including:

a light source (110) configured to project a light beam while continuously varying a wavelength thereof;

an interferometer (120) including a splitting unit (121) configured to split the light beam projected from the light source into light beams radiated toward a plurality of spots on a measurement target (T), the interferometer (120) being configured to generate interference beams with the light beams split in correspondence with the plurality of spots, each of the interference beams being generated by interference between a measurement beam radiated toward the measurement target (T) and reflected at the measurement target (T) and a reference beam passing through an optical path that is at least partially different from an optical path of the measurement beam;

a light-receiving unit (130) configured to receive the interference beams from the interferometer; and

a processor (140) configured to detect a peak of the received interference beams, and calculate a distance to the measurement target by associating the detected peak with one of the plurality of spots,

wherein an optical path length difference between the measurement beam and the reference beam is different among the light beams split in correspondence with the plurality of spots.

### LIST OF REFERENCE NUMERALS

1 Sensor system
10 Displacement sensor
11 Control device
12 Control signal input sensor
13 Externally connected device
20 Sensor head
21 Objective lens
22, 22a to 22c Collimating lens
23 Objective lens holder
24, 24a to 24c Collimating lens unit
30 Controller
31 Display unit
32 Setting unit
33 External interface (I/F) unit
34 Optical fiber cable connector
35 External storage unit
36 Measurement processor
40 Optical fiber cable
51 Wavelength-swept light source
52 Optical amplifier
53, 53a to 53b Isolator
54, 54a to 54j Optical coupler
55 Attenuator
56a to 56c Light-receiving element
57 Multiplexer circuit
58 AD conversion unit
59 Processor
60 Balance detector
61 Correction signal generation unit
71a to 71e Light-receiving element
72a to 72c Amplifier circuit
73 Multiplexer circuit
74 AD conversion unit
75 Processor
76 Differential amplifier circuit
77 Correction signal generation unit
100 Optical interference range sensor
110 Wavelength-swept light source
120 Interferometer
121 Splitting unit
122a to 122c Collimating lens
130 Light-receiving unit
131 Light-receiving element
132 AD conversion unit
140 Processor
T Measurement target
Lm1 to Lm3 Measurement optical path
Lr1 to Lr3 Reference optical path

1. An optical interference range sensor comprising:
a light source configured to project a light beam while continuously varying a wavelength thereof;
an interferometer comprising a splitting unit configured to split the light beam projected from the light source into light beams radiated toward a plurality of spots on a measurement target, the interferometer being configured to generate interference beams with the light beams split in correspondence with the plurality of spots, each of the interference beams being generated by interference between a measurement beam radiated toward the measurement target and reflected at the measurement target and a reference beam passing through an optical path that is at least partially different from an optical path of the measurement beam;
a light-receiving unit configured to receive the interference beams from the interferometer; and
a processor configured to detect a peak of the received interference beams, and calculate a distance to the measurement target by associating the detected peak with one of the spots,
wherein an optical path length difference between the measurement beam and the reference beam is different among the light beams split in correspondence with the plurality of spots.

2. The optical interference range sensor according to claim 1,
wherein peaks of the interference beams are shifted from each other.

3. The optical interference range sensor according to claim 1,
wherein the interferometer generates each of the interference beams by interference between a first reflected beam that is a reflected beam of the measurement beam radiated toward the measurement target and reflected at the measurement target and a second reflected beam that is a reflected beam of the reference beam reflected at a reference surface.

4. The optical interference range sensor according to claim 3,
wherein positions of leading ends of optical fiber cables for transmitting the respective light beams split in correspondence with the plurality of spots are shifted with respect to each other in an optical axis direction, each of the leading ends serving as the reference surface.

5. The optical interference range sensor according to claim 1,
wherein a difference ΔL in the optical path length difference among the light beams split in correspondence with the plurality of spots is at least larger than a distance resolution δL_{FWHM}, which is represented by:
δL_{FWHM}=c/nδf
(where c: speed of light, n: refractive index in optical path difference, δf: frequency sweep width).

6. The optical interference range sensor according to claim 1,
wherein the optical path length difference is set so that distances between adjacent peaks of the interference beams are different, and
the processor calculates the distance to the measurement target by associating the detected peak with the one of the spots, based on the distances between the adjacent peaks and a preset optical path length difference.

7. The optical interference range sensor according to claim 1,
wherein the processor calculates the distance to the measurement target by associating the detected peak with the one of the spots, based on the detected peak and a detected peak of an interference beam received in the past.

8. The optical interference range sensor according to claim 1,
wherein the light-receiving unit comprises an adjustment unit configured to equalize an amount of light of the interference beams corresponding to the respective spots.

9. The optical interference range sensor according to claim 1,
wherein the processor generates a signal waveform by converting, to a distance by means of sub-pixel estimation, discrete values obtained by frequency-analyzing the interference beams received by the light-receiving unit.

10. The optical interference range sensor according to claim 1,
wherein the processor obtains the distance to the measurement target by averaging distance values calculated by associating the detected peak with the one of the spots.

11. The optical interference range sensor according to claim 1,
wherein the processor obtains the distance to the measurement target by averaging distance values calculated based on a peak having a signal intensity that is not smaller than a predetermined value, out of a plurality of the detected peaks.

12. The optical interference range sensor according to claim 2,
wherein the interferometer generates each of the interference beams by interference between a first reflected beam that is a reflected beam of the measurement beam radiated toward the measurement target and reflected at the measurement target and a second reflected beam that is a reflected beam of the reference beam reflected at a reference surface.

13. The optical interference range sensor according to claim 2,
wherein a difference ΔL in the optical path length difference among the light beams split in correspondence with the plurality of spots is at least larger than a distance resolution δL_{FWHM}, which is represented by:
δL_{FWHM}=c/nδf
(where c: speed of light, n: refractive index in optical path difference, δf: frequency sweep width).

14. The optical interference range sensor according to claim 3,
wherein a difference ΔL in the optical path length difference among the light beams split in correspondence with the plurality of spots is at least larger than a distance resolution δL_{FWHM}, which is represented by:
δL_{FWHM}=c/nδf
(where c: speed of light, n: refractive index in optical path difference, δf: frequency sweep width).

15. The optical interference range sensor according to claim 4,
wherein a difference ΔL in the optical path length difference among the light beams split in correspondence with the plurality of spots is at least larger than a distance resolution δL_{FWHM}, which is represented by:
δL_{FWHM}=c/nδf
(where c: speed of light, n: refractive index in optical path difference, δf: frequency sweep width).

16. The optical interference range sensor according to claim 2,
wherein the optical path length difference is set so that distances between adjacent peaks of the interference beams are different, and
the processor calculates the distance to the measurement target by associating the detected peak with the one of the spots, based on the distances between the adjacent peaks and a preset optical path length difference.

17. The optical interference range sensor according to claim 3,
wherein the optical path length difference is set so that distances between adjacent peaks of the interference beams are different, and
the processor calculates the distance to the measurement target by associating the detected peak with the one of the spots, based on the distances between the adjacent peaks and a preset optical path length difference.

18. The optical interference range sensor according to claim 4,
wherein the optical path length difference is set so that distances between adjacent peaks of the interference beams are different, and
the processor calculates the distance to the measurement target by associating the detected peak with the one of the spots, based on the distances between the adjacent peaks and a preset optical path length difference.

19. The optical interference range sensor according to claim 5,
wherein the optical path length difference is set so that distances between adjacent peaks of the interference beams are different, and
the processor calculates the distance to the measurement target by associating the detected peak with the one of the spots, based on the distances between the adjacent peaks and a preset optical path length difference.

20. The optical interference range sensor according to claim 2,
wherein the processor calculates the distance to the measurement target by associating the detected peak with the one of the spots, based on the detected peak and a detected peak of an interference beam received in the past.
